(19) United States
(12) Patent Application Publication
(10) Pub. No.: US 2023/0394296 A1
(43) Pub. Date: Dec. 7, 2023

(54) NEURAL NETWORK INFERENCING EFFICIENCY WITH FEWER PARAMETERS

(71) Applicant: GE Precision Healthcare LLC, Wauwatosa, WI (US)

(72) Inventors: Tao Tan, Nuenen (NL); Gopal B. Avinash, Concord, CA (US); Ludovic Boilevin Kayl, Versailles (FR); Vincent Bismuth, Buc (FR); Michel S. Tohme, Wauwatosa, WI (US); German Guillermo Vera Gonzalez, Menomonee Falls, WI (US)

(21) Appl. No.: 17/805,375

(22) Filed: Jun. 3, 2022

(51) Int. Cl. G06N 3/08

(52) U.S. Cl. CPC G06N 3/08

(57) ABSTRACT

Systems/techniques that facilitate improved neural network inferencing efficiency with fewer parameters are provided. In various embodiments, a system can access a medical image on which an artificial intelligence task is to be performed. In various aspects, the system can facilitate the artificial intelligence task by executing a neural network pipeline on the medical image, thereby yielding an artificial intelligence task output that corresponds to the medical image. In various instances, the neural network pipeline can include respective skip connections from the medical image, prior to any convolutions, to each convolutional layer in the neural network pipeline.

### TECHNICAL FIELD

The subject disclosure relates generally to neural networks, and more specifically to improved neural network inferencing efficiency with fewer parameters.

### BACKGROUND

Deep learning neural networks can exhibit high accuracy and/or high precision for various image analysis tasks. However, deployment of such deep learning neural networks is often limited by hardware processing capacities and/or inferencing speed requirements. Accordingly, systems and/or techniques that can address one or more of these technical problems can be desirable.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus and/or computer program products that facilitate improved neural network inferencing efficiency with fewer parameters are described.

According to one or more embodiments, a system is provided. The system can comprise a computer-readable memory that can store computer-executable components. The system can further comprise a processor that can be operably coupled to the computer-readable memory and that can execute the computer-executable components stored in the computer-readable memory. In various embodiments, the computer-executable components can comprise a receiver component. In various cases, the receiver component can access a medical image on which an artificial intelligence task is to be performed. In various aspects, the computer-executable components can further comprise a model component. In various cases, the model component can facilitate the artificial intelligence task by executing a neural network pipeline on the medical image, thereby yielding an artificial intelligence task output that corresponds to the medical image. In various instances, the neural network pipeline can include respective skip connections from the medical image, prior to any convolutions, to each convolutional layer in the neural network pipeline.

According to one or more embodiments, the above-described system can be implemented as a computer-implemented method and/or a computer program product.

### DESCRIPTION OF THE DRAWINGS

FIG. 1 illustrates a block diagram of an example, non-limiting system that facilitates improved neural network inferencing efficiency with fewer parameters in accordance with one or more embodiments described herein.

FIG. 2 illustrates a block diagram of an example, non-limiting system including a neural network pipeline and/or an artificial intelligence task output that facilitates improved neural network inferencing efficiency with fewer parameters in accordance with one or more embodiments described herein.

FIG. 3 illustrates a block diagram of an example, non-limiting neural network pipeline in accordance with one or more embodiments described herein.

FIG. 4 illustrates a block diagram of an example, non-limiting system including a training component and/or a training dataset that facilitates improved neural network inferencing efficiency with fewer parameters in accordance with one or more embodiments described herein.

FIG. 5 illustrates a block diagram of an example, non-limiting training dataset in accordance with one or more embodiments described herein.

FIG. 6 illustrates an example, non-limiting block diagram showing how a neural network pipeline can be trained on a training dataset in accordance with one or more embodiments described herein.

FIG. 7 illustrates an example, non-limiting block diagram showing how training of a neural network pipeline can be improved via translation invariance in accordance with one or more embodiments described herein.

FIGS. 8-11 illustrate example, non-limiting experimental results pertaining to various embodiments described herein.

FIG. 12 illustrates a flow diagram of an example, non-limiting computer-implemented method that facilitates improved neural network inferencing efficiency with fewer parameters in accordance with one or more embodiments described herein.

FIG. 13 illustrates a block diagram of an example, non-limiting operating environment in which one or more embodiments described herein can be facilitated.

FIG. 14 illustrates an example networking environment operable to execute various implementations described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Deep learning neural networks can exhibit high accuracy and/or high precision for various image analysis tasks. Non-limiting examples of such image analysis tasks can include image classification (e.g., where a deep learning neural network can receive as input an image and can produce as output a label that indicates to which class the image most likely belongs), image segmentation (e.g., where a deep learning neural network can receive as input an image and can produce as output a pixel-wise and/or voxel-wise segmentation mask corresponding to the image), image denoising (e.g., where a deep learning neural network can receive as input an image and can produce as output a denoised version of the image), and/or image style transfer (e.g., where a deep learning neural network can receive as input an image captured according to a given imaging style/modality and can produce as output a version of the image according to a different imaging style/modality).

However, deployment of such deep learning neural networks can often be limited by hardware processing capacities and/or inferencing speed requirements. More specifically, the physical computing hardware on which a deep learning neural network is deployed/implemented can have a limited amount of processing power (e.g., a limited amount of random access memory (RAM), a limited amount of disk storage space). Because a deep learning neural network can often have tens of thousands, hundreds of thousands, and/or even millions of internal parameters (e.g., internal weight vectors/matrices, internal bias vectors/matrices), implementation of deep learning neural networks on such physical computing hardware can quickly consume such limited amount of processing power, which can be undesirable. Furthermore, it can be desired to execute and/or inference a deep learning neural network as quickly as possible/feasible. However, as the number of internal parameters within a deep learning neural network grows, the amount of time required to execute/inference the deep learning neural network can commensurately grow. Thus, deep learning neural networks that include tens of thousands, hundreds of thousands, and/or even millions of internal parameters can be more likely to consume excessive amounts of time during execution/inferencing, which can be undesirable. In other words, although increasing the number of internal parameters can help to improve the accuracy/precision of a deep learning neural network, such increase in the number of internal parameters can concomitantly consume excessive amounts of hardware processing power and/or excessive amounts of execution time. Note that such drawbacks of increasing the number of internal parameters of a deep learning neural network can be exacerbated in the medical/clinical/hospital context, where processing power and/or time can be valued at premiums.

Accordingly, systems and/or techniques that can address one or more of these technical problems can be desirable.

Various embodiments described herein can address one or more of these technical problems. One or more embodiments described herein can include systems, computer-implemented methods, apparatus, and/or computer program products that can facilitate improved neural network inferencing efficiency with fewer parameters. In other words, the inventors of various embodiments described herein devised various techniques for reducing the total number of parameters in a deep learning neural network and/or for increasing the execution speed of a deep learning neural network, without negatively affecting performance (e.g., accuracy/precision). More specifically, such techniques devised by the present inventors can include: implementing skip connections from an input image to each and/or every convolutional layer in a deep learning neural network; implementing shared parameters (e.g., shared weights, shared biases) in specific sub-networks of the deep learning neural network; implementing sub-network supervision during training of the deep learning neural network; and/or enforcing translation-invariant losses during training of the deep learning neural network.

In particular, the present inventors realized that including skip connections from the inputted image to each convolutional layer in the deep learning neural network can cause each convolutional layer to have original information on which to rely, which can allow for a significant reduction (e.g., about ⅓ reduction) in the number of convolutional kernels utilized by the deep learning neural network. In other words, a deep learning neural network that does not include skip connections from the inputted image to each/every convolutional layer can exhibit a given level of performance and a given number of convolutional kernels, and an otherwise equivalent deep learning neural network that does include skip connections from the inputted image to each/every convolution layer can exhibit the same given level of performance (if not better performance) while including fewer than the given number of convolutional kernels.

Note that including skip connections from the inputted image to each/every convolutional layer is not equivalent to a densenet architecture. Specifically, in a densenet architecture, every single layer (whether or not convolutional) of a deep learning neural network receives, as input, activations from every preceding layer and sends, as output, its own activations to every succeeding/following layer. Such a densenet architecture results in very large and/or increased numbers of internal parameters (e.g., very many weight vectors/matrices, very many bias vectors/matrices), hence the name “dense”. Such very large/increased numbers of internal parameters are contrary to the purposes of the herein-described embodiments. In contrast, the architecture devised by the present inventors does not involve every layer (convolutional and non-convolutional) receiving input from every previous layer and sending output to every following layer. Instead, the architecture devised by the present inventors can include feeding, via skip connections, the inputted image to every convolutional layer in the deep learning neural network, not to all layers (convolutional and non-convolutional alike) in the deep learning neural network. Indeed, in some cases, these skip connections from the inputted image to each/every convolutional layer can be the only skip connections in the deep learning neural network. In other words, as described herein, every convolutional layer in the deep learning neural network can receive, as input, activations from the immediately previous layer (not necessarily from all previous layers) and can also receive, as input, the original inputted image. Furthermore, such convolutional layer can send, as output, its own activations to the immediately following layer (not necessarily to all following layers). Again, contrast this with a densenet architecture, in which each layer (whether or not convolutional) would receive, as input, activations from every single previous layer and would provide, as output, its own activations to every single following layer; such an architecture would dramatically increase, rather than decrease, the total number of internal parameters.

In any case, and as experimentally verified by the present inventors, the result of implementing skip connections from the inputted image to every convolutional layer as described herein can be that the number of convolutional kernels (e.g., number of parameters) can be reduced without negatively affecting the accuracy/precision of the deep learning neural network.

In various aspects, the present inventors further realized that including shared parameters in specific sub-networks of the deep learning neural network can further reduce the total number of parameters without negatively affecting accuracy/precision. Specifically, when analyzing an inputted image, a deep learning neural network can include a decomposition layer that decomposes the inputted image into a plurality of down-sampled sub-images. In various instances, there can be a plurality of parallel sub-networks within the deep learning neural network (e.g., each sub-network being any suitable stack of any suitable layers), where the plurality of parallel sub-networks can be considered as respectively corresponding (e.g., in one-to-one fashion) to the plurality of down-sampled sub-images. In other words, for any given down-sampled sub-image from the plurality of down-sampled sub-images, there can be a respectively corresponding sub-network in the plurality of parallel sub-networks that receives and processes the given down-sampled sub-image. Thus, the plurality of down-sampled sub-images can be considered as being independently processed in parallel with each other. The individual outputs of the plurality of parallel sub-networks can then be fed together to a remainder (e.g., to remaining layers) of the deep learning neural network. In various cases, the present inventors realized that the plurality of parallel sub-networks can have shared parameters and that such shared parameters can refrain from negatively affecting the accuracy/precision of the deep learning neural network. That is, each of the plurality of parallel sub-networks can have the same internal parameters (e.g., the same weight vectors/matrices, the same bias vectors/matrices) as each other. In various aspects, and as experimentally verified by the present inventors, such shared parameters can reduce the total number of independent parameters that need to be learned/stored by the deep learning neural network, without adversely impacting the performance of the deep learning neural network.

In various aspects, the present inventors further realized that including sub-network supervision during training of the deep learning neural network can help to prevent a reduction in total number of parameters from adversely affecting accuracy/precision. As mentioned above, in various instances, the deep learning neural network can be considered as having a plurality of parallel sub-networks that can respectively analyze/process the plurality of down-sampled sub-images. Existing techniques for training the deep learning neural network in a supervised fashion include: feeding the deep learning neural network a training image, thereby causing the deep learning neural network to produce some full-image output; computing an error/loss between the full-image output and a full-image ground-truth annotation that corresponds to the training image; and performing backpropagation on the deep learning neural network based on such error/loss. In contrast, the present inventors realized that superior learning can be achieved by performing supervised training of each of the plurality of parallel sub-networks, not just by performing supervised training on the deep learning neural network overall. For instance, there can be a training image that is associated with a full-image ground-truth annotation and also with a plurality of sub-image ground-truth annotations. In various cases, the training image can be fed to the deep learning neural network, which can cause the deep learning neural network to produce some full-image output and which can also cause the plurality of parallel sub-networks to produce a plurality of sub-image outputs. In various aspects, a first error/loss can be computed between the full-image output and the full-image ground-truth annotation. Moreover, in various instances, a plurality of second errors/losses can be respectively computed between the plurality of sub-image outputs and the plurality of sub-image ground-truth annotations. In various cases, backpropagation of the plurality of parallel sub-networks can be performed based on the plurality of second errors/losses, and/or backpropagation of the remainder of the deep learning neural network can be performed based on the first error/loss. In various aspects, performing backpropagation on the plurality of parallel sub-networks based on the plurality of second errors/losses can be considered having a regularization effect that can help to resolve convergence issues of the deep learning neural network. In other words, implementing sub-network supervision in this way can be considered as an improved technique for training the deep learning neural network.

In various aspects, the present inventors further realized that enforcing translation-invariant loss during training of the deep learning neural network can also help to prevent a reduction in total number of parameters from adversely affecting accuracy/precision. As mentioned above, the deep learning neural network can be trained in supervised fashion by: feeding the deep learning neural network a training image, thereby causing the deep learning neural network to produce some full-image output; computing an error/loss between the full-image output and the a full-image ground-truth annotation that corresponds to the training image; and performing backpropagation on the deep learning neural network based on the error/loss. In various aspects, the present inventors realized that further training of the deep learning neural network can be conducted as follows: the training image can be translated and/or shifted in any suitable fashion (e.g., shifted upward or downward by x pixels/voxels for any suitable positive integer x, shifted left or right by y pixels/voxels for any suitable positive integer y); a full-image ground-truth annotation for the shifted/translated training image can be obtained (e.g., for image classification tasks, the full-image ground-truth annotation of the shifted/translated training image can be equivalent to that of the unshifted/untranslated training image; for image segmentation/denoising tasks, the full-image ground-truth annotation of the shifted/translated training image can be obtained by commensurately shifting/translating the full-image ground-truth annotation of the unshifted/untranslated training image); the shifted/translated training image can be fed to the deep learning neural network, thereby causing the deep learning neural network to produce some full-image output; an error/loss can be computed between the full-image output and the full-image ground-truth annotation of the shifted/translated training image; and backpropagation can be performed on the deep learning neural network based on the error/loss.

Indeed, in some aspects, such training can even be performed in the absence of ground-truth annotations. For example, a training image can be fed to the deep learning neural network, thereby causing the deep learning neural network to produce some first full-image output; the training image can be shifted/translated in any suitable fashion; the shifted/translated training image can be fed to the deep learning neural network, thereby causing the deep learning neural network to produce some second full-image output; an error/loss can be computed between the first full-image output and the second full-image output (e.g., for classification tasks) or between the first full-image output and an inverse-shifted/inverse-translated version of the second full-image output (e.g., for segmentation/denoising tasks); and backpropagation can be performed on the deep learning neural network based on the error/loss.

In any case, such training can be considered as causing the deep learning neural network to become agnostic to pixel-wise and/or voxel-wise translations/shifts (e.g., to become translation-invariant), and such translation-invariance can help the deep learning neural network to retain accuracy/precision despite having fewer internal parameters.

In various embodiments, any suitable combination of the aforementioned techniques (e.g., skip connections to convolutional layers, shared weights for parallel sub-networks, sub-network supervision, and/or translation-invariant training) can be implemented so as to reduce the number of internal parameters utilized by the deep learning neural network, while simultaneously preserving (and/or even improving) the accuracy/precision of the deep learning neural network.

In various aspects, various embodiments described herein can be considered as a computerized tool (e.g., any suitable combination of computer-executable hardware and/or computer-executable software) for facilitating improved neural network inferencing efficiency with fewer parameters. In various instances, such computerized tool can comprise a receiver component, a model component, and/or an execution component.

In various aspects, the receiver component of the computerized tool can electronically receive and/or otherwise electronically access a medical image. In various instances, the receiver component can electronically retrieve the medical image from any suitable centralized and/or decentralized database (e.g., graph database, relational database, hybrid database) as desired, whether remote from and/or local to the receiver component. In other instances, the receiver component can electronically retrieve the medical image from any suitable imaging device (e.g., computed tomography (CT) scanner, magnetic resonance imaging (MRI) scanner, X-ray scanner, ultrasound scanner, positron emission tomography (PET) scanner) that captured and/or generated the medical image. In any case, the receiver component can electronically obtain and/or access the medical image, such that other components of the computerized tool can electronically interact with (e.g., read, write, edit, manipulate) the medical image.

In various aspects, the medical image can exhibit any suitable format and/or dimensionality as desired. For example, in some instances, the medical image can be a two-dimensional pixel-array of Hounsfield units. In other instances, the medical image can be a three-dimensional voxel-array of Hounsfield units. Furthermore, the medical image can be generated by, captured by, and/or otherwise associated with any suitable type of medical imaging modality as desired. As some non-limiting examples, the medical image can have been captured/generated by a CT scanner, by an MM scanner, by an X-ray scanner, by an ultrasound scanner, and/or by a PET scanner. Further still, the medical image can have undergone any suitable type of image reconstruction and/or can have been captured/generated by any suitable type of imaging protocol. In any case, the medical image can visually depict any suitable anatomical structure (e.g., body part, organ, tissue), and/or portion thereof, of any suitable medical patient (e.g., human, animal, and/or otherwise).

In various aspects, it can be desired to perform some artificial intelligence task on the medical image. In various instances, the artificial intelligence task can be any suitable task pertaining to computerized image analysis as desired. As some non-limiting examples, the artificial intelligence task can be image classification (e.g., to determine to which of a plurality of different classes, such as disease/symptom classes, the medical image likely belongs), image segmentation (e.g., to generate a pixel-wise and/or voxel-wise mask that indicates/identifies different structures, such as different types of tissues, throughout the medical image), image denoising (e.g., to generate a version of the medical image that exhibits less visual noise/blurring than the medical image), image style transfer (e.g., to transform/convert the medical image from one modality/style to another), and/or image resolution enhancement (e.g., to generate a version of the medical image that has higher visual resolution/clarity than the medical image). In any case, the computerized tool, as described herein, can perform the artificial intelligence task on the medical image.

In various embodiments, the model component of the computerized tool can electronically store, maintain, control, and/or otherwise access a neural network pipeline. In various aspects, the neural network pipeline can exhibit any suitable number of layers (e.g., input layer, one or more hidden layers, output layer), any suitable numbers of neurons in various layers (e.g., different layers can have the same and/or different numbers of neurons as each other), any suitable activation functions (e.g., sigmoid, softmax, hyperbolic tangent, rectified linear unit) in various neurons (e.g., different neurons can have the same and/or different activation functions as each other), and/or any suitable interneuron connections (e.g., forward connections, skip connections, recurrent connections). In various instances, the model component can electronically execute the neural network pipeline on the medical image, thereby yielding an artificial intelligence task output. That is, the model component can feed the medical image to an input layer of the neural network pipeline, the medical image can complete a forward pass through one or more hidden layers of the neural network pipeline, and/or an output layer of the neural network pipeline can compute the artificial intelligence task output based on activations provided by the one or more hidden layers.

In any case, the format of the artificial intelligence task output can depend upon the artificial intelligence task that is desired to be performed on the medical image. For example, if it is desired to perform image classification on the medical image, then the layers of the neural network pipeline can be controllably configured so that the artificial intelligence task output can be a classification label. As another example, if it is desired to perform image segmentation on the medical image, then the layers of the neural network pipeline can be controllably configured so that the artificial intelligence task output can be a pixel-wise and/or voxel-wise segmentation mask. As yet another example, if it is desired to perform image denoising on the medical image, then the layers of the neural network pipeline can be controllably configured so that the artificial intelligence task output can be a denoised version of the medical image.

In various aspects, the internal structure/architecture of the neural network pipeline can include the following: a decomposition layer; a set of parallel sub-networks serially following the decomposition layer; another sub-network serially following the set of parallel sub-networks; and one or more aggregation layers serially following the another sub-network.

In various instances, the decomposition layer can receive as input the medical image and can produce as output a set of down-sampled sub-images. In various cases, the set of down-sampled sub-images can include any suitable number of down-sampled sub-images. Those having ordinary skill in the art will appreciate how a pixel-array and/or a voxel-array can be down-sampled/decomposed. As a non-limiting example, the medical image can be a two-dimensional pixel-array, and the set of down-sampled sub-images can include four down-sampled sub-images: a first down-sampled sub-image that the decomposition layer can produce by replacing each non-overlapping two-by-two pixel patch of the medical image with the top-left pixel of that pixel patch; a second down-sampled sub-image that the decomposition layer can produce by replacing each non-overlapping two-by-two pixel patch of the medical image with the top-right pixel of that pixel patch; a third down-sampled sub-image that the decomposition layer can produce by replacing each non-overlapping two-by-two pixel patch of the medical image with the bottom-left pixel of that pixel patch; and/or a fourth down-sampled sub-image that the decomposition layer can produce by replacing each non-overlapping two-by-two pixel patch of the medical image with the bottom-right pixel of that pixel patch.

As another non-limiting example, the medical image can be a three-dimensional voxel-array, and the set of down-sampled sub-images can include eight down-sampled sub-images: a first down-sampled sub-image that the decomposition layer can produce by replacing each non-overlapping two-by-two-by-two voxel patch of the medical image with the top-back-left voxel of that voxel patch; a second down-sampled sub-image that the decomposition layer can produce by replacing each non-overlapping two-by-two-by-two voxel patch of the medical image with the top-back-right voxel of that voxel patch; a third down-sampled sub-image that the decomposition layer can produce by replacing each non-overlapping two-by-two-by-two voxel patch of the medical image with the top-front-left voxel of that voxel patch; a fourth down-sampled sub-image that the decomposition layer can produce by replacing each non-overlapping two-by-two-by-two voxel patch of the medical image with the top-front-right voxel of that voxel patch; a fifth down-sampled sub-image that the decomposition layer can produce by replacing each non-overlapping two-by-two-by-two voxel patch of the medical image with the bottom-back-left voxel of that voxel patch; a sixth down-sampled sub-image that the decomposition layer can produce by replacing each non-overlapping two-by-two-by-two voxel patch of the medical image with the bottom-back-right voxel of that voxel patch; a seventh down-sampled sub-image that the decomposition layer can produce by replacing each non-overlapping two-by-two-by-two voxel patch of the medical image with the bottom-front-left voxel of that voxel patch; and/or an eighth down-sampled sub-image that the decomposition layer can produce by replacing each non-overlapping two-by-two-by-two voxel patch of the medical image with the bottom-front-right voxel of that voxel patch.

In various aspects, the set of parallel sub-networks can respectively correspond (e.g., in one-to-one fashion) to the set of down-sampled sub-images. More specifically, in various instances, for any given down-sampled sub-image in the set of down-sampled sub-images, there can be a respectively corresponding sub-network in the set of parallel sub-networks that can receive as input and subsequently process/analyze the given down-sampled sub-image. In various cases, each sub-network of the set of parallel sub-networks can include any suitable number of layers, any suitable numbers of neurons in various layers, any suitable activation functions in various neurons, and/or any suitable interneuron connections. In some aspects, each sub-network of the set of parallel sub-networks can include any suitable numbers/types of convolutional layers and/or any suitable numbers/types of non-convolutional layers, where such convolutional layers and/or non-convolutional layers can be arranged in any suitable order and/or fashion as desired. Further, in various instances, the set of parallel sub-networks can be isolated from each other (e.g., any given layer within one of the set of parallel sub-networks can refrain from receiving as input any activation produced by any layer within a different one of the set of parallel sub-networks). Further still, in various cases, the set of parallel sub-networks can all have shared weights. In other words, the set of parallel sub-networks can all have the same structure/architecture as each other (e.g., can all have the same numbers, types, and/or arrangement of layers as each other; can all have the same internal weight vectors/matrices as each other; can all have the same internal bias values as each other; can all have the same interneuron connections as each other). As mentioned above, such shared weights can allow for a decrease in the total number of parameters to be learned/stored by the neural network pipeline without a corresponding decrease in accuracy/performance of the neural network pipeline. In any case, each of the set of down-sampled sub-images can complete a forward pass through a respectively corresponding one of the set of parallel sub-networks.

In various aspects, the output activations generated by the set of parallel sub-networks can all be received as input by the another sub-network. In various instances, the another sub-network can include any suitable number of layers, any suitable numbers of neurons in various layers, any suitable activation functions in various neurons, and/or any suitable interneuron connections. In some cases, the another sub-network can include any suitable numbers/types of convolutional layers and/or any suitable numbers/types of non-convolutional layers, where such convolutional layers and/or non-convolutional layers can be arranged in any suitable order and/or fashion as desired. In various aspects, the another sub-network can have a different structure/architecture (e.g., can have different numbers, types, and/or arrangement of layers; can have different internal weight vectors/matrices; can have different internal bias values; and/or can have different interneuron connections) than each of the set of parallel sub-networks. In some instances, the another sub-network can be considered as a convolutional neural network and/or as a fully convolutional network.

In any case, the activations outputted by the set of parallel sub-networks can all be received as input by the another sub-network, such activations can complete a forward pass through the another sub-network, and the another sub-network can generate as output a set of sub-image outputs that respectively correspond (e.g., in one-to-one fashion) to the set of down-sampled sub-images. In various aspects, the format of each of the set of sub-image outputs can depend upon the artificial intelligence task that is desired to be performed on the medical image. For example, if it is desired to perform image classification on the medical image, then the set of parallel sub-networks and/or the another sub-network can be controllably configured so that each of the set of sub-image outputs can be a classification label that corresponds to a respective one of the set of down-sampled sub-images. As another example, if it is desired to perform image segmentation on the medical image, then the set of parallel sub-networks and/or the another sub-network can be controllably configured so that each of the set of sub-image outputs can be a pixel-wise and/or voxel-wise segmentation mask that corresponds to a respective one of the set of down-sampled sub-images. As yet another example, if it is desired to perform image denoising on the medical image, then the set of parallel sub-networks and/or the another sub-network can be controllably configured so that each of the set of sub-image outputs can be a denoised version of a respective one of the set of down-sampled sub-images.

In various aspects, the one or more aggregation layers of the neural network pipeline can receive as input all of the set of sub-image outputs. In various instances, the one or more aggregation layers can include any suitable number of layers, any suitable numbers of neurons in various layers, any suitable activation functions in various neurons, and/or any suitable interneuron connections. In various cases, the one or more aggregation layers can include any suitable numbers/types of convolutional layers and/or any suitable numbers/types of non-convolutional layers, arranged in any suitable order and/or fashion as desired. In various aspects, the one or more aggregation layers can have a different structure/architecture (e.g., can have different numbers, types, and/or arrangement of layers; can have different internal weight vectors/matrices; can have different internal bias values; and/or can have different interneuron connections) than each of the set of parallel sub-networks and/or than the another sub-network. In any case, the set of sub-image outputs can collectively complete a forward pass through the one or more aggregation layers, and the result of such forward pass can be the artificial intelligence task output for the medical image.

As a further structural/architectural detail, in various aspects, the medical image can be skip-connected to each and/or every convolutional layer in the neural network pipeline. That is, the medical image (e.g., an unaltered and/or unconvolved copy of the medical image) can be received as input by each/every convolutional layer within each of the set of parallel sub-networks, the medical image (e.g., an unaltered and/or unconvolved copy of the medical image) can be received as input by each/every convolutional layer within the another sub-network, and/or the medical image (e.g., an unaltered and/or unconvolved copy of the medical image) can be received as input by each/every convolutional layer within the one or more aggregation layers. In some cases, these can be the only skip connections in the neural network pipeline. As mentioned above, the implementation of skip connections from the medical image to each/every convolutional layer in the neural network pipeline can allow the neural network pipeline to achieve a sufficient/satisfactory level of accuracy/precision with fewer convolutional kernels (e.g., fewer internal parameters).

In some embodiments, the neural network pipeline can exhibit a U-net architecture. In such case, the medical image can nevertheless be skip-connected to each/every convolutional layer in such U-net architecture. However, to facilitate such skip connections, the medical image can first have to be appropriately resized and/or down-sampled at each level of the U-net architecture. Those having ordinary skill in the art will appreciate how to perform such resizing/down-sampling.

In any case, the model component of the computerized tool can electronically generate the artificial intelligence task output by executing the neural network pipeline on the medical image.

In various embodiments, the execution component of the computerized tool can, in some cases, electronically render the artificial intelligence task output on any suitable computer screen/display/monitor (e.g., such that a medical professional can visually inspect the artificial intelligence task output so as to perform a diagnosis and/or prognosis). In other cases, the execution component can electronically transmit the artificial intelligence task output to any suitable computing device as desired.

In order for the neural network pipeline to accurately/precisely generate the artificial intelligence task output, the neural network pipeline should first undergo training. Accordingly, in various embodiments, the receiver component of the computerized tool can electronically receive, retrieve, and/or otherwise access a training dataset, and the computerized tool can further comprise a training component that can train the neural network pipeline on the training dataset.

In various aspects, the training dataset can include a set of training medical images. In various instances, the set of training medical images can include any suitable number of training medical images. In various cases, each training medical image can have the same format and/or dimensionality as the medical image itself (e.g., if the medical image is a two-dimensional array of pixels, then each training medical image can likewise be a two-dimensional array of pixels; if the medical image is instead a three-dimensional array of voxels, then each training medical image can likewise be a three-dimensional array of voxels).

In various aspects, the training dataset can further include a set of ground-truth annotations that respectively correspond to the set of training medical images. That is, for each given training medical image, there can be a ground-truth annotation that corresponds to the given training medical image. In various instances, the ground-truth annotation can include a full-image ground-truth annotation and a set of sub-image ground-truth annotations that respectively correspond (e.g., in one-to-one fashion) to the set of parallel sub-networks. In various cases, the full-image ground-truth annotation can have the same format and/or dimensionality as the artificial intelligence task output produced by the neural network pipeline and/or can represent the correct/accurate result that should be obtained if the artificial intelligence task were correctly/accurately applied to the given training medical image. Similarly, in various aspects, each sub-image ground-truth annotation can have the same format and/or dimensionality as any of the set of sub-image outputs produced by the neural network pipeline and/or can represent the correct/accurate result that should be obtained if the artificial intelligence task were accurately/precisely applied to a down-sampled version of the given training medical image. Accordingly, when a particular training medical image corresponds to a particular ground-truth annotation, that particular ground-truth annotation can be considered as indicating: a specific output (e.g., a full-image ground-truth annotation) that the one or more aggregation layers of the neural network pipeline would generate if the neural network pipeline correctly/accurately analyzed the particular training medical image; and specific outputs (e.g., a set of sub-image ground-truth annotations) that the set of parallel sub-networks and/or the another sub-network would generate if the neural network pipeline correctly/accurately analyzed the particular training medical image.

In various aspects, the training component can train the neural network pipeline on the training dataset as follows. In various instances, the internal parameters (e.g., weights, biases) of the neural network pipeline can be randomly initialized. In various cases, the training component can select from the training dataset a training medical image. Furthermore, the training component can select from the training dataset a ground-truth annotation that corresponds to the selected training medical image. As mentioned above, the selected ground-truth annotation can include a full-image ground-truth annotation (e.g., indicating the correct/accurate artificial intelligence task result that is known/deemed to correspond to the selected training medical image) and/or a set of sub-image ground-truth annotations (e.g., indicating the correct/accurate artificial intelligence task results that are known/deemed to correspond to down-sampled versions of the selected training medical image).

In various aspects, the training component can feed the selected training medical image to the neural network pipeline, thereby causing the neural network pipeline to generate some full-image output and some set of sub-image outputs. That is, the selected training medical image can be received by the decomposition layer, which can generate a set of down-sampled sub-images based on the selected training medical image; the set of down-sampled sub-images can complete respective forward passes through the set of parallel sub-networks and the another sub-network, thereby yielding the set of sub-image outputs; and/or the set of sub-image outputs can complete a forward pass through the one or more aggregation layers, thereby yielding the full-image output. Note that, the full-image output and/or the set of sub-image outputs can be considered as the artificial intelligence task results (e.g., classifications, segmentations, denoised versions) that the neural network pipeline believes/infers should correspond to the selected training medical image, whereas the selected ground-truth annotation can be considered as representing the accurate/correct artificial intelligence task results that are known/deemed to correspond to the selected training medical image. Further still, note that, if the neural network pipeline has so far undergone no and/or little training, then the full-image output and/or the set of sub-image outputs can be highly inaccurate (e.g., the full-image output can be very different from the full-image ground-truth annotation, and/or the set of sub-image outputs can respectively be very different from the set of sub-image ground-truth annotations).

In any case, the training component can compute various errors/losses between the outputs of the neural network pipeline and the selected ground-truth annotation and can perform backpropagation on the neural network pipeline based on such errors/losses. More specifically, the training component can compute a first error/loss between the full-image output and the full-image ground-truth annotation, the training component can compute a set of second errors/losses between the set of sub-image outputs and the set of sub-image ground-truth annotations, the training component can perform backpropagation on the set of parallel sub-networks and/or the another sub-network based on the set of second errors/losses, and/or the training component can perform backpropagation on the remainder of the neural network pipeline (e.g., the one or more aggregation layers) based on the first error/loss. In any case, such backpropagation can iteratively update the internal parameters of the neural network pipeline.

In various aspects, the training component can repeat the above training procedure for each training medical image in the training dataset, which can cause the internal parameters of the neural network pipeline to become iteratively optimized for accurately performing the artificial intelligence task on the inputted medical images. Those having ordinary skill in the art will appreciate that any suitable training batch sizes, any suitable training termination criteria, and/or any suitable loss/error/objective functions can be implemented by the training component.

In any case, because each ground-truth annotation in the training dataset can include a set of sub-image ground-truth annotations, and because the training component can update the internal parameters of the set of parallel sub-networks and/or the another sub-network based on such sub-image ground-truth annotations, such training can be considered and/or referred to as sub-network supervision. In various aspects, as experimentally verified by the present inventors, such sub-network supervision can help to improve the accuracy/precision of the neural network pipeline, despite a reduction in total number of parameters due to sharing of weights between the set of parallel sub-networks and/or due to skip connections to each/every convolutional layer.

In various instances, the training component can perform further training of the neural network pipeline as follows. For any given training medical image and/or for any given full-image ground-truth annotation that corresponds to the given training medical image, the training component can shift and/or translate (and/or, in some cases, rotate and/or reflect) the pixels/voxels of the given training medical image in any suitable fashion, thereby yielding a shifted/translated training medical image. If the artificial intelligence task is image classification, then the shifted/translated training medical image can be considered as corresponding to the given full-image ground-truth annotation. Accordingly, the training component can feed the translated/shifted training medical image to the neural network pipeline and can perform backpropagation based on the given full-image ground-truth annotation. In contrast, if the artificial intelligence task is image segmentation, image denoising, image style transfer, image resolution enhancement, and/or any other type of image-to-image task, then the training component can also shift and/or translate (and/or, in some cases, rotate and/or reflect) the given full-image ground-truth annotation in the same way/fashion that the training medical image was shifted/translated, thereby yielding a shifted/translated ground-truth annotation. Accordingly, the training component can feed the translated/shifted training medical image to the neural network pipeline and can perform backpropagation based on the shifted/translated full-image ground-truth annotation. In any case, such training can cause the neural network pipeline to become agnostic to pixel/voxel shifts/translations. Accordingly, such training can be referred to as translation invariance training.

In some aspects, an alternative version of translation invariance training can be performed in the absence of ground-truths. For example, suppose that there is a training medical image that lacks a ground-truth annotation (e.g., the ground-truth annotation can be unknown and/or unavailable). In such case, the training component can feed the training medical image to the neural network pipeline, thereby causing the neural network pipeline (e.g., the one or more aggregation layers) to generate some first full-image output. In various instances, the training component can shift/translate (and/or rotate/reflect) the training medical image in any suitable fashion, thereby yielding a shifted/translated training medical image. In various cases, the training component can then feed the shifted/translated training medical image to the neural network pipeline, thereby causing the neural network pipeline (e.g., the one or more aggregation layers) to produce some second full-image output. If the artificial intelligence task is image classification, then the training component can compute an error/loss between the first full-image output and the second full-image output, and the training component can perform backpropagation based on the error/loss. In contrast, if the artificial intelligence task is some image-to-image task (e.g., image segmentation, image denoising, image resolution enhancement), then the training component can inverse-shift and/or inverse-translate (and/or inverse-rotate and/or inverse-reflect) the second full-image output (e.g., can shift/translate the second full-image output in an opposite/inverse direction/fashion as the training medical image was shifted/translated), thereby yielding an inverse-shifted/inverse-translated full-image output. In various aspects, the training component can then compute an error/loss between the first full-image output and the inverse-shifted/inverse-translated full-image output, and the training component can perform backpropagation based on such error/loss.

In any case, as experimentally verified by the present inventors, such translation invariance training can help to improve the accuracy/precision of the neural network pipeline, despite a reduction in total number of parameters due to sharing of weights between the set of parallel sub-networks and/or due to skip connections to each/every convolutional layer.

Accordingly, various embodiments described herein can be considered as a computerized tool for facilitating improved neural network inferencing efficiency with fewer parameters. More specifically, such computerized tool can reduce the total number of internal parameters of a neural network pipeline while simultaneously preserving (and/or even improving) the performance of the neural network pipeline, by implementing skip connections from an inputted medical image to each/every convolutional layer in the pipeline, by implementing shared weights in a set of parallel sub-networks of the pipeline, by training the pipeline via sub-network supervision, and/or by training the pipeline via translation-invariant losses.

Various embodiments described herein can be employed to use hardware and/or software to solve problems that are highly technical in nature (e.g., to facilitate improved neural network inferencing efficiency with fewer parameters), that are not abstract and that cannot be performed as a set of mental acts by a human. Further, some of the processes performed can be performed by a specialized computer (e.g., a neural network pipeline comprising various convolutional layers, various sub-networks having shared weights, and/or various skip connections) for carrying out defined tasks related to improved neural network inferencing efficiency with fewer parameters. For example, such defined tasks can include: accessing, by a device operatively coupled to a processor, a medical image on which an artificial intelligence task is to be performed; and facilitating, by the device, the artificial intelligence task by executing a neural network pipeline on the medical image, thereby yielding an artificial intelligence task output that corresponds to the medical image, wherein the neural network pipeline includes respective skip connections from the medical image, prior to any convolutions, to each convolutional layer in the neural network pipeline.

In some cases, the artificial intelligence task can be image classification, and such defined tasks can further comprise: executing, by the device, the neural network pipeline on a training medical image, thereby yielding a reference full-image output; shifting, by the device, the training medical image in pixel-wise or voxel-wise fashion, thereby yielding a shifted training medical image; executing, by the device, the neural network pipeline on the shifted training medical image, thereby yielding another full-image output; and updating, by the device, internal parameters of the neural network pipeline based on an error between the reference full-image output and the another full-image output. In other cases, the artificial intelligence task can be image segmentation or image denoising, and such defined tasks can further comprise: executing, by the device, the neural network pipeline on a training medical image, thereby yielding a reference full-image output; shifting, by the device, the training medical image in pixel-wise or voxel-wise fashion, thereby yielding a shifted training medical image; executing, by the device, the neural network pipeline on the shifted training medical image, thereby yielding another full-image output; inverse-shifting, by the device, the another full-image output in pixel-wise or voxel-wise fashion, thereby yielding an inverse-shifted full-image output; and updating, by the device, internal parameters of the neural network pipeline based on an error between the reference full-image output and the inverse-shifted full-image output.

In various aspects, the neural network pipeline can further include: a decomposition layer that decomposes the medical image into a plurality of down-sampled sub-images; and a plurality of parallel sub-networks that respectively analyze the plurality of down-sampled sub-images, wherein the plurality of parallel sub-networks can have shared weights.

In various instances, such defined tasks can further comprise: training, by the device, the neural network pipeline on a training dataset, wherein the training dataset includes a set of training medical images, wherein each of the set of training medical images corresponds to a full-image ground-truth annotation and a plurality of down-sampled sub-image ground-truth annotations, wherein such pluralities of down-sampled sub-image ground-truth annotations are leveraged to train the plurality of parallel sub-networks, and wherein such full-image ground-truth annotations are leveraged to train a remainder of the neural network pipeline.

Such defined tasks are not performed manually by humans. Indeed, neither the human mind nor a human with pen and paper can electronically access a medical image, electronically execute a neural network pipeline on the medical image, where the neural network pipeline includes skip connections from the medical image to each/every convolutional layer and further includes shared weights in various portions of the neural network pipeline, electronically train the neural network pipeline in translation invariant fashion based on shifted/translated training medical images, and/or electronically train the neural network pipeline in sub-network supervised fashion. Instead, various embodiments described herein are inherently and inextricably tied to computer technology and cannot be implemented outside of a computing environment (e.g., a neural network pipeline is an inherently-computerized construct that simply cannot be implemented in any way by the human mind without computers; accordingly, a computerized tool that executes and/or trains a neural network pipeline in specified ways is likewise inherently-computerized and cannot be implemented in any sensible, practical, or reasonable way without computers).

Moreover, various embodiments described herein can integrate into a practical application various teachings relating to improved neural network inferencing efficiency with fewer parameters. As explained above, deep learning neural networks can have as many as tens of thousands, hundreds of thousands, and/or even millions of internal parameters. Such large number of internal parameters can excessively consume processing power (e.g., RAM, disk space) of the physical computing hardware on which such deep learning neural networks are implemented. Moreover, such large number of internal parameters can cause such deep learning neural networks to consume excessive amounts of time during execution. To address these issues, the present inventors devised various techniques by which to reduce the total number of parameters within a deep learning neural network pipeline without negatively affecting (and, in some cases, even improving) the accuracy/precision of the deep learning neural network pipeline. Such techniques can include: incorporating skip connections from an inputted medical image to each/every convolutional layer in the pipeline; incorporating a set of parallel sub-networks in the pipeline that have shared weights; incorporating sub-network supervision during training; and/or incorporating translation invariant loss during training. As experimentally verified by the present inventors, the first two of such techniques can help to reduce the total number of internal parameters of the pipeline, while the latter two of such techniques can help to preserve and/or improve the accuracy/precision of the pipeline despite such fewer internal parameters. A computerized tool that can implement such techniques within a neural network pipeline certainly constitutes a concrete and tangible technical improvement in the field of neural networks. Therefore, various embodiments described herein clearly qualify as useful and practical applications of computers.

Furthermore, various embodiments described herein can control real-world tangible devices based on the disclosed teachings. For example, various embodiments described herein can electronically execute real-world neural network layers and/or can electronically render real-world results, messages, and/or images on real-world computer screens based on such execution of real-world neural network layers.

It should be appreciated that the herein figures and description provide non-limiting examples of various embodiments and are not necessarily drawn to scale.

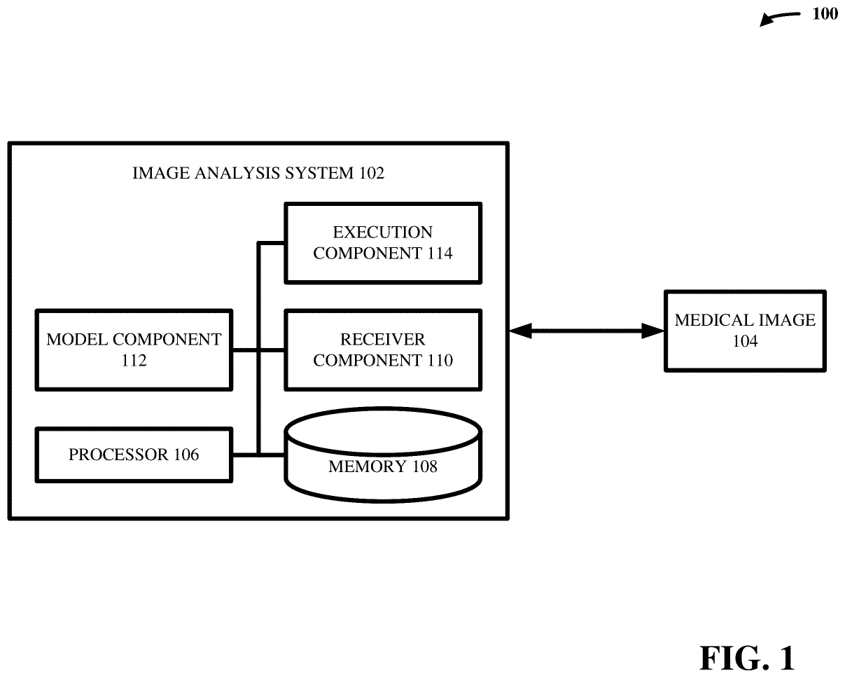

FIG. 1 illustrates a block diagram of an example, non-limiting system 100 that can facilitate improved neural network inferencing efficiency with fewer parameters in accordance with one or more embodiments described herein. As shown, an image analysis system 102 can be electronically integrated, via any suitable wired and/or wireless electronic connections, with a medical image 104.

In various aspects, the medical image 104 can visually depict and/or otherwise visually illustrate any suitable anatomical structure (e.g., body part, organ, tissue, bone, artery, blood vessel) of any suitable medical patient (e.g., human, animal, and/or otherwise). In various instances, the medical image 104 can exhibit any suitable format and/or dimensionality. For example, in some cases, the medical image can be an a-by-b pixel array for any suitable positive integers a and b. As another example, the medical image 104 can be an a-by-b-by-c voxel array for any suitable positive integers a, b, and c. In various aspects, the medical image 104 can have been created and/or otherwise generated by any suitable medical imaging modality. As a non-limiting example, the medical image 104 can have been generated and/or captured by any suitable CT scanner. As another non-limiting example, the medical image 104 can have been generated/captured by any suitable MM scanner. As still another non-limiting example, the medical image 104 can have been generated/captured by any suitable X-ray scanner. As yet another non-limiting example, the medical image 104 can have been generated/captured by any suitable ultrasound scanner. As even another non-limiting example, the medical image 104 can have been generated/captured by any suitable PET scanner. In various aspects, the medical image 104 can have undergone any suitable image reconstruction technique, any suitable imaging protocol technique, any suitable image manipulation technique, and/or any suitable image editing technique.

In any case, it can be desired to perform an artificial intelligence task on the medical image 104. In various aspects, the artificial intelligence task can be any suitable computerized task that pertains to image analysis. For example, the artificial intelligence task can be image classification. In such case, it can be desired to identify to which of a plurality of classes (e.g., to which of a plurality of disease classes, to which of a plurality of symptom classes, to which of a plurality of injury/malady classes, to which of a plurality of treatment classes) the medical image 104, as a whole, most likely belongs. As another example, the artificial intelligence task can be image segmentation. In such case, it can be desired to generate a pixel-wise and/or voxel-wise mask that indicates which specific pixels/voxels of the medical image 104 belong to which of a plurality of classes (e.g., to which of a plurality of structural classes, such as a bone tissue class, a soft tissue class, a lung tissue class, a brain tissue class, a tumor class, and/or a calcification class). As still another example, the artificial intelligence task can be image denoising. In such case, it can be desired to generate a transformed/converted version of the medical image 104, which transformed/converted version exhibits less visual noise than the medical image 104. As yet another example, the artificial intelligence task can be image style transfer. In such case, the medical image 104 can be considered as exhibiting visual characteristics associated with some imaging modality (e.g., CT characteristics), and it can be desired to generate a transformed/converted version of the medical image 104, which transformed/converted version exhibits visual characteristics associated with a different imaging modality (e.g., MM characteristics). In any case, the image analysis system 102 can, as described herein, facilitate the artificial intelligence task on the medical image 104.

In various embodiments, the image analysis system 102 can comprise a processor 106 (e.g., computer processing unit, microprocessor) and a computer-readable memory 108 that is operably and/or operatively and/or communicatively connected/coupled to the processor 106. The computer-readable memory 108 can store computer-executable instructions which, upon execution by the processor 106, can cause the processor 106 and/or other components of the image analysis system 102 (e.g., receiver component 110, model component 112, execution component 114) to perform one or more acts. In various embodiments, the computer-readable memory 108 can store computer-executable components (e.g., receiver component 110, model component 112, execution component 114), and the processor 106 can execute the computer-executable components.

In various embodiments, the image analysis system 102 can comprise a receiver component 110. In various aspects, the receiver component 110 can electronically receive and/or otherwise electronically access the medical image 104. In some instances, the receiver component 110 can electronically retrieve the medical image 104 from any suitable centralized and/or decentralized databases and/or data structures (not shown), whether remote from and/or local to the receiver component 110. In other instances, the receiver component 110 can electronically retrieve the medical image 104 from the medical imaging modality (e.g., CT scanner, Mill scanner, X-ray scanner, ultrasound scanner, PET scanner) that generated, captured, and/or reconstructed the medical image 104. In any case, the receiver component 110 can electronically obtain and/or access the medical image 104, such that other components of the image analysis system 102 can electronically interact with the medical image 104.

In various embodiments, the image analysis system 102 can further comprise a model component 112. In various aspects, as described herein, the model component 112 can electronically execute a neural network pipeline on the medical image 104, thereby yielding an artificial intelligence task output. In various cases, the neural network pipeline can be structured and/or trained in various specific fashions so as to reduce a total number of internal parameters without negatively affecting performance.

In various embodiments, the image analysis system 102 can further comprise an execution component 114. In various instances, the execution component 114 can electronically render the artificial intelligence task output on any suitable computing screen and/or can electronically transmit the artificial intelligence task output to any suitable computing device.

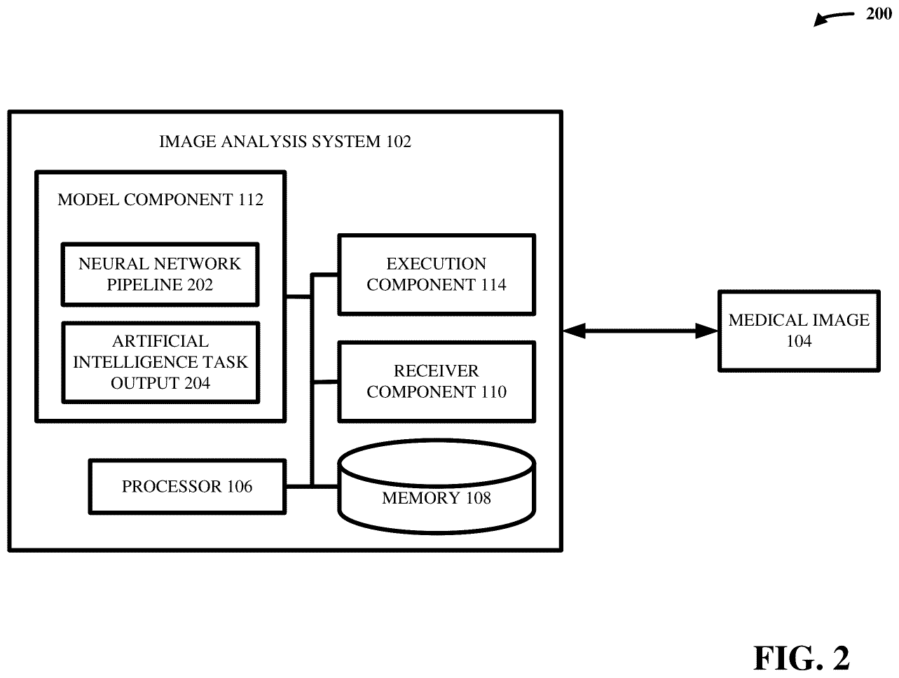

FIG. 2 illustrates a block diagram of an example, non-limiting system 200 including a neural network pipeline and/or an artificial intelligence task output that can facilitate improved neural network inferencing efficiency with fewer parameters in accordance with one or more embodiments described herein. As shown, the system 200 can, in some cases, comprise the same components as the system 100, and can further comprise a neural network pipeline 202 and/or an artificial intelligence task output 204.

In various embodiments, the model component 112 can electronically store, electronically maintain, electronically control, and/or otherwise electronically access a neural network pipeline 202. In various aspects, the neural network pipeline 202 can have any suitable numbers and/or types of neural network layers, can have any suitable numbers of neurons in various neural network layers, can have any suitable activation functions in various neurons, and/or can have any suitable interneuron connections. In any case, the neural network pipeline 202 can be configured to perform the artificial intelligence task on the medical image 104. Accordingly, in various aspects, the model component 112 can execute the neural network pipeline 202 on the medical image 104, and the result of such execution can be the artificial intelligence task output 204. More specifically, the model component 112 can feed the medical image 104 to an input layer of the neural network pipeline 202, the medical image 104 can complete a forward pass through one or more hidden layers of the neural network pipeline 202, and/or an output layer of the neural network pipeline 202 can compute the artificial intelligence task output 204 based on activation maps provided by the one or more hidden layers.

In various instances, the artificial intelligence task output 204 can be any suitable electronic data (e.g., one or more scalars, one or more vectors, one or more matrices, one or more tensors, and/or one or more character strings) whose format, dimensionality, and/or content can depend upon the artificial intelligence task that is desired to be performed on the medical image 104. For example, suppose that the artificial intelligence task is image classification. In such case, the neural network pipeline 202 can be controllably configured so that the artificial intelligence task output 204 is a classification label that indicates/identifies to which class the medical image 104 most likely belongs (e.g., according to the belief/inference of the neural network pipeline 202). As another example, suppose that the artificial intelligence task is image segmentation. In such case, the neural network pipeline 202 can be controllably configured so that the artificial intelligence task output 204 is a pixel-wise and/or voxel-wise segmentation mask indicating/identifying which pixels/voxels of the medical image 104 most likely belong (e.g., according to the belief/inference of the neural network pipeline 202) to which classes. As even another example, suppose that the artificial intelligence task is image denoising. In such case, the neural network pipeline 202 can be controllably configured so that the artificial intelligence task output 204 is a version of the medical image 104 that exhibits/contains less visual noise than the medical image 104.

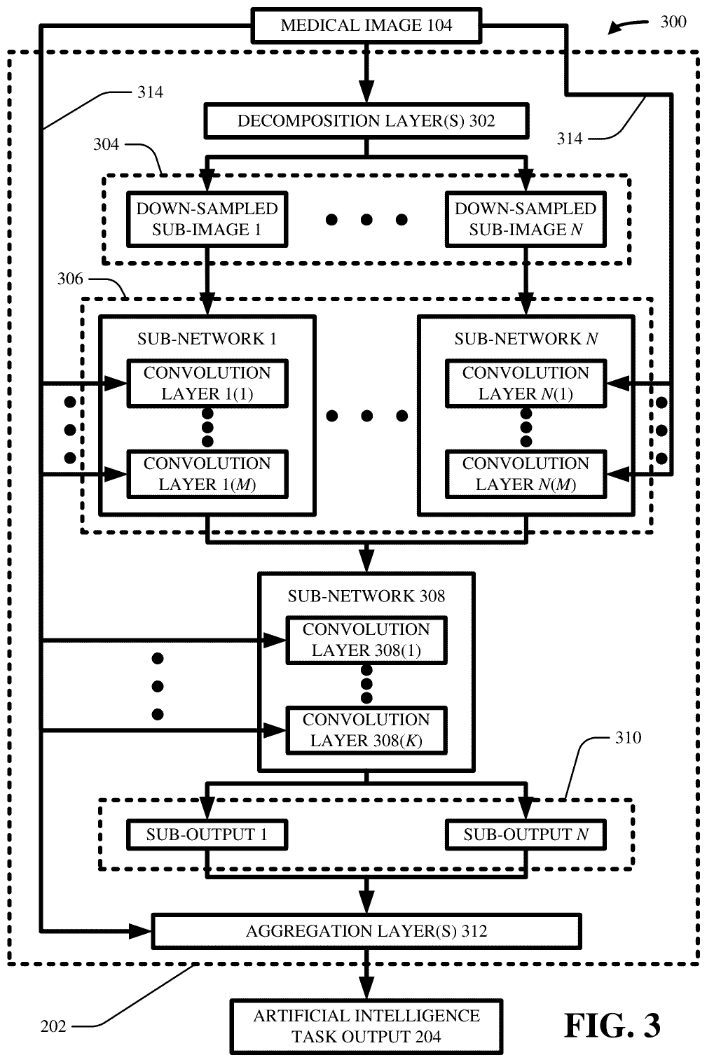

In various cases, various structural/architecture details of the neural network pipeline 202 are more fully discussed with respect to FIG. 3.

FIG. 3 illustrates a block diagram 300 of an example, non-limiting neural network pipeline in accordance with one or more embodiments described herein. That is, FIG. 3 depicts a non-limiting example embodiment of the neural network pipeline 202.

In various embodiments, as shown, the neural network pipeline 202 can comprise one or more decomposition layers 302, a set of parallel sub-networks 306, a sub-network 308, and/or one or more aggregation layers 312. In various aspects, as shown, the one or more decomposition layers 302 can receive as input the medical image 104 and can produce as output a set of down-sampled sub-images 304. In various instances, the set of down-sampled sub-images 304 can include n sub-images for any suitable positive integer n: a down-sampled sub-image 1 to a down-sampled sub-image n. In various cases, those having ordinary skill in the art will appreciate how the one or more decomposition layers 302 can down-sample and/or otherwise decompose the medical image 104 into the set of down-sampled sub-images 304. As a non-limiting example, suppose that the medical image 104 is a two-dimensional pixel array that can be fully tiled and/or fully covered by a plurality of non-overlapping and uniformly-oriented g-by-h pixel patches, for any suitable positive integers g and h where gh=n. In such case, each of such g-by-h pixel patches can be considered as containing n pixels, and the one or more decomposition layers 302 can generate the set of down-sampled sub-images 304 by uniformly retaining a different pixel from each of such g-by-h pixel patches. For instance, the one or more decomposition layers 302 can generate the down-sampled sub-image 1 by retaining the first pixel (and discarding the remaining n−1 pixels) in each of the plurality of non-overlapping and uniformly-oriented g-by-h pixel patches, and the one or more decomposition layers 302 can generate the down-sampled sub-image n by retaining the n-th pixel (and discarding the remaining n−1 pixels) in each of the plurality of non-overlapping and uniformly-oriented g-by-h pixel patches. As another non-limiting example, suppose that the medical image 104 is a three-dimensional voxel array that can be fully tiled and/or fully covered by a plurality of non-overlapping and uniformly-oriented g-by-h-by-i voxel patches, for any suitable positive integers g, h, and i where ghi=n. In such case, each of such g-by-h-by-i voxel patches can be considered as containing n voxels, and the one or more decomposition layers 302 can generate the set of down-sampled sub-images 304 by uniformly retaining a different voxel from each of such g-by-h-by-i voxel patches. For instance, the one or more decomposition layers 302 can generate the down-sampled sub-image 1 by retaining the first voxel (and discarding the remaining n−1 voxels) in each of the plurality of non-overlapping and uniformly-oriented g-by-h-by-i voxel patches, and the one or more decomposition layers 302 can generate the down-sampled sub-image n by retaining the n-th voxel (and discarding the remaining n−1 voxels) in each of the plurality of non-overlapping and uniformly-oriented g-by-h-by-i voxel patches.

In any case, each of the set of down-sampled sub-images 304 can be considered as being a scaled-down and/or dimensionally-reduced version of the medical image 104. For instance, if the medical image 104 is a two-dimensional pixel array, then each of the set of down-sampled sub-images 304 can be a scaled-down and/or dimensionally-smaller pixel-array. Likewise, if the medical image 104 is a three-dimensional voxel array, then each of the set of down-sampled sub-images 304 can be a scaled-down and/or dimensionally-smaller voxel-array. In various instances, those having ordinary skill in the art will appreciate that the set of down-sampled sub-images 304 can all have the same format and/or dimensionality as each other.

In various aspects, the set of down-sampled sub-images 304 can be respectively received as input by the set of parallel sub-networks 306. In various instances, as shown, the set of parallel sub-networks 306 can respectively correspond (e.g., in one-to-one fashion) to the set of down-sampled sub-images 304. Accordingly, since the set of down-sampled sub-images 304 can include n sub-images, the set of parallel sub-networks 306 can include n sub-networks: a sub-network 1 to a sub-network n. For example, the sub-network 1 can correspond to the down-sampled sub-image 1. That is, the sub-network 1 can receive as input, and thus can subsequently process, the down-sampled sub-image 1 and/or can refrain from receiving as input, and thus can refrain from subsequently processing, the remainder of the set of down-sampled sub-images 304. Likewise, as another example, the sub-network n can correspond to the down-sampled sub-image n. So, the sub-network n can receive as input, and thus can subsequently process, the down-sampled sub-image n and/or can refrain from receiving as input, and thus can refrain from subsequently processing, the remainder of the set of down-sampled sub-images 304.

In various cases, each of the set of parallel sub-networks 306 can include any suitable numbers and/or types of neural network layers, any suitable numbers of neurons in various neural network layers, any suitable activation functions in various neurons, and/or any suitable interneuron connections. In particular, each of the set of parallel sub-networks 306 can include any suitable number and/or arrangement of convolutional layers. For example, the sub-network 1 can include m convolutional layers for any suitable positive integer m: a convolutional layer 1(1) to a convolutional layer 1(m). Although not explicitly shown in FIG. 3, the sub-network 1 can further include any other suitable numbers and/or types of non-convolutional layers (e.g., batch normalization layers) that can be located in any suitable arrangement/order before, after, and/or in between such m convolutional layers. Similarly, as shown, the sub-network n can include m convolutional layers: a convolutional layer n(1) to a convolutional layer n(m). Again, although not explicitly shown in FIG. 3, the sub-network n can further include any other suitable numbers and/or types of non-convolutional layers (e.g., batch normalization layers) that can be located in any suitable arrangement/order before, after, and/or in between such m convolutional layers.

In various aspects, as shown, the set of parallel sub-networks 306 can be arranged to be in parallel, as opposed to in series, with each other, hence the name “parallel sub-networks”. Furthermore, in various instances, the set of parallel sub-networks 306 can be isolated from one another. For instance, it can be the case that no layer of the sub-network 1 can receive as input an activation produced by any layer belonging to any of the other sub-networks in the set of parallel sub-networks 306. In other words, there can be an absence of interneuron connections between the sub-network 1 and any of the other sub-networks in the set of parallel sub-networks 306. Similarly, it can be the case that no layer of the sub-network n can receive as input an activation produced by any layer belonging to any of the other sub-networks in the set of parallel sub-networks 306. Again, this can mean that there can be an absence of interneuron connections between the sub-network n and any of the other sub-networks in the set of parallel sub-networks 306.

Further still, in various aspects, the set of parallel sub-networks 306 can all share weights with each other. That is, each of the set of parallel sub-networks 306 can have the same numbers, types, and/or arrangements of neural network layers as each other; can have the same numbers and/or arrangements of neurons as each other; can have the same weight vectors/matrices and/or bias vectors/matrices as each other; and/or can have the same types/arrangements of interneuron connections as each other. In other words, the set of parallel sub-networks 306 can all be structured identically as each other. For example, the sub-network 1 can be structured identically as the sub-network n (e.g., the convolution layer 1(1) can have the same weights, the same biases, and/or the same convolutional kernel values as the convolutional layer n(1); the convolution layer 1(m) can have the same weights, the same biases, and/or the same convolutional kernel values as the convolutional layer n(m)). In various cases, such sharing of weights (e.g., such identical layer arrangements, layer structures, and/or parameter values) can help to reduce the total number of unique internal parameters to be stored/learned by the neural network pipeline 202. For instance, if the set of parallel sub-networks 306 did not share weights, the neural network pipeline 202 would have to learn/store n different sets of voluminous internal parameter values: one set of internal parameter values per parallel sub-network. In contrast, because the set of parallel sub-networks 306 can have shared weights, the neural network pipeline 202 can have to learn/store merely one set of voluminous internal parameters as opposed to n sets, and each of the set of parallel sub-networks 306 can utilize that one set of learned/stored internal parameters. Accordingly, the total number of internal parameters can be considered as being reduced by such weight sharing.

In any case, as shown, the set of down-sampled sub-images 304 can complete respective forward passes through the set of parallel sub-networks 306, and the final activations respectively generated by the set of parallel sub-networks 306 can be received by a sub-network 308. For example, the down-sampled sub-image 1 can complete a forward pass through the sub-network 1, and the activations outputted by a final layer of the sub-network 1 can be fed to the sub-network 308. Similarly, the down-sampled sub-image n can complete a forward pass through the sub-network n, and the activations outputted by a final layer of the sub-network n can also be fed to the sub-network 308.

In various aspects, the sub-network 308 can include any suitable numbers and/or types of neural network layers, any suitable numbers of neurons in various neural network layers, any suitable activation functions in various neurons, and/or any suitable interneuron connections. In particular, the sub-network 308 can include any suitable number and/or arrangement of convolutional layers. For example, the sub-network 308 can include k convolutional layers for any suitable positive integer k: a convolutional layer 308(1) to a convolutional layer 308(k). Although not explicitly shown in FIG. 3, the sub-network 308 can further include any other suitable numbers and/or types of non-convolutional layers (e.g., batch normalization layers) that can be located in any suitable arrangement/order before, after, and/or in between such k convolutional layers. In various instances, the sub-network 308 can refrain from sharing weights with the set of parallel sub-networks 306. In other words, the sub-network 308 can be structured differently (e.g., can have different numbers, types, and/or arrangements of layers; can have different numbers/arrangements of neurons; can have different weight vectors/matrices; can have different bias vectors/matrices; and/or can have different interneuron connections) than any of the set of parallel sub-networks 306.

In any case, as shown, the activations respectively outputted by the set of parallel sub-networks 306 can collectively complete a forward pass through the sub-network 308, which can cause the sub-network 308 to generate a set of sub-outputs 310. In various aspects, the set of sub-outputs 310 can be considered as respectively corresponding to the set of down-sampled sub-images 304 and/or to the set of parallel sub-networks 306. Thus, because the set of down-sampled sub-images 304 can have n down-sampled sub-images, and/or because the set of parallel sub-networks 306 can have n sub-networks, the set of sub-outputs 310 can likewise have n sub-outputs: a sub-output 1 to a sub-output n. In various instances, each of the set of sub-outputs 310 can be any suitable electronic data (e.g., one or more scalars, one or more vectors, one or more matrices, one or more tensors, and/or one or more character strings) whose format, dimensionality, and/or content can depend upon the artificial intelligence task that is desired to be performed on the medical image 104. For example, if the artificial intelligence task is image classification, then each of the set of sub-outputs 310 can be a classification label. However, rather than classifying the medical image 104 itself, each of the set of sub-outputs 310 can instead be considered as classifying a respective one of the set of down-sampled sub-images 304 (e.g., the sub-output 1 can be an inferred classification label that indicates to which class the down-sampled sub-image 1 most likely belongs, according to the inference/belief of the sub-network 1 and/or the sub-network 308; the sub-output n can be an inferred classification label that indicates to which class the down-sampled sub-image n most likely belongs, according to the inference/belief of the sub-network n and/or the sub-network 308).

As another example, if the artificial intelligence task is image segmentation, then each of the set of sub-outputs 310 can be a pixel-wise and/or voxel-wise segmentation mask. However, rather than segmenting the medical image 104 itself, each of the set of sub-outputs 310 can instead be considered as segmenting a respective one of the set of down-sampled sub-images 304 (e.g., the sub-output 1 can be an inferred pixel-wise and/or voxel-wise segmentation mask that indicates which pixels/voxels of the down-sampled sub-image 1 most likely belong to which classes, according to the inference/belief of the sub-network 1 and/or the sub-network 308; the sub-output n can be an inferred pixel-wise and/or voxel-wise segmentation mask that indicates which pixels/voxels of the down-sampled sub-image n most likely belong to which classes, according to the inference/belief of the sub-network n and/or the sub-network 308).

As yet another example, if the artificial intelligence task is image denoising, then each of the set of sub-outputs 310 can be a denoised image. However, rather than being denoised versions of the medical image 104 itself, each of the set of sub-outputs 310 can instead be considered as a denoised version of a respective one of the set of down-sampled sub-images 304 (e.g., the sub-output 1 can be an inferred denoised version of the down-sampled sub-image 1, according to the inference/belief of the sub-network 1 and/or the sub-network 308; the sub-output n can be an inferred denoised version of the down-sampled sub-image n, according to the inference/belief of the sub-network n and/or the sub-network 308).

In various aspects, as shown, the set of sub-outputs 310 can collectively complete a forward pass through the one or more aggregation layers 312, which can cause the one or more aggregation layers 312 to generate the artificial intelligence task output 204. In various instances, the one or more aggregation layers 312 can include any suitable numbers and/or types of neural network layers, any suitable numbers of neurons in various neural network layers, any suitable activation functions in various neurons, and/or any suitable interneuron connections. In some cases, the one or more aggregation layers 312 can include convolutional layers. In other cases, the one or more aggregation layers 312 can lack convolutional layers. In any case, the one or more aggregation layers 312 can be considered as not sharing weights with the set of parallel sub-networks 306 and/or with the sub-network 308. That is, the one or more aggregation layers 312 can be structured differently (e.g., can have different numbers, types, and/or arrangements of layers; can have different numbers/arrangements of neurons; can have different weight vectors/matrices; can have different bias vectors/matrices; and/or can have different interneuron connections) than any of the set of parallel sub-networks 306 and/or than the sub-network 308.

As a further structural detail, as shown, the neural network pipeline 202 can, in various aspects, include skip connections 314 from the medical image 104 to each and/or every convolutional layer within the neural network pipeline 202. For example, in various instances, each/every convolutional layer of the sub-network 1 can receive the medical image 104 as input, due to the skip connections 314. As another example, in various cases, each/every convolutional layer of the sub-network n can receive the medical image 104 as input, due to the skip connections 314. As still another example, in various aspects, each/every convolutional layer of the sub-network 308 can receive the medical image 104 as input, due to the skip connections 314. As even another example, in various instances, each/every convolutional layer of the one or more aggregation layers 312 (if the one or more aggregation layers 312 include convolutional layers) can receive the medical image 104 as input, due to the skip connections 314.

Note that, because the medical image 104 can be coupled to each/every convolutional layer of the neural network pipeline 202 by the skip connections 314, such convolutional layers can be considered as having access to the original, unconvolved, and/or unaltered version of the medical image 104. In contrast, if the skip connections 314 were absent, then each convolutional layer in the neural network pipeline 202 would have access only to an altered, convolved, edited, and/or otherwise manipulated version of the medical image 104 created by the previous layers of the neural network pipeline 202. As experimentally verified by the present inventors, the inclusion of the skip connections 314 can allow the convolutional layers of the neural network pipeline 202 to have fewer convolutional kernels, without experiencing a loss in accuracy/precision. For instance, suppose that, with the skip connections 314 implemented as shown, the neural network pipeline 202 can achieve a given level of accuracy/precision, and the convolutional layers of the neural network pipeline 202 (e.g., of each of the set of parallel sub-networks 306, of the sub-network 308, and/or of the one or more aggregation layers 312) can have a particular number of kernels. Now, suppose that the skip connections 314 were eliminated/removed. In such case, if the convolutional layers of the neural network pipeline 202 had the same particular number of kernels, the neural network pipeline 202 would achieve less than the particular level of accuracy/precision. In other words, if the skip connections 314 are eliminated/removed, the convolutional layers of the neural network pipeline 202 would have to include more kernels in order for the neural network pipeline 202 to achieve the same particular level of accuracy/precision. Accordingly, the skip connections 314 can be considered as allowing for a reduction in the number of convolutional kernels (e.g., in the number of internal parameters) while preserving (and/or even boosting, in some cases) the accuracy/precision of the neural network pipeline 202. In some non-limiting cases, the skip connections 314 can be the only skip connections within the neural network pipeline 202.

Although not explicitly shown in FIG. 3, the neural network pipeline 202 can, in some embodiments, exhibit a U-net architecture. In such case, shared weights between the set of parallel sub-networks 306 can be implemented as described above. Moreover, in such case, the skip connections 314 can also be implemented as described above. However, those having ordinary skill in the art will appreciate that, in order to implement the skip connections 314 with a U-net architecture, appropriate down-sampling can be required for and/or along each of the skip connections 314 (e.g., so as to appropriately resize the medical image 104 at each level of the U-net structure).

In any case, the model component 112 can electronically execute the neural network pipeline 202 on the medical image 104, thereby yielding the artificial intelligence task output 204.

In various embodiments, the execution component 114 can electronically render the artificial intelligence task output 204 on any suitable computer screen, display, and/or monitor (not shown) as desired. Accordingly, a medical professional (e.g., an attending physician) can visually inspect the artificial intelligence task output 204 and/or can make a diagnostic/prognostic decision based on the artificial intelligence task output 204. In other cases, the execution component 114 can electronically transmit the artificial intelligence task output 204 to any suitable computing device (not shown) as desired.

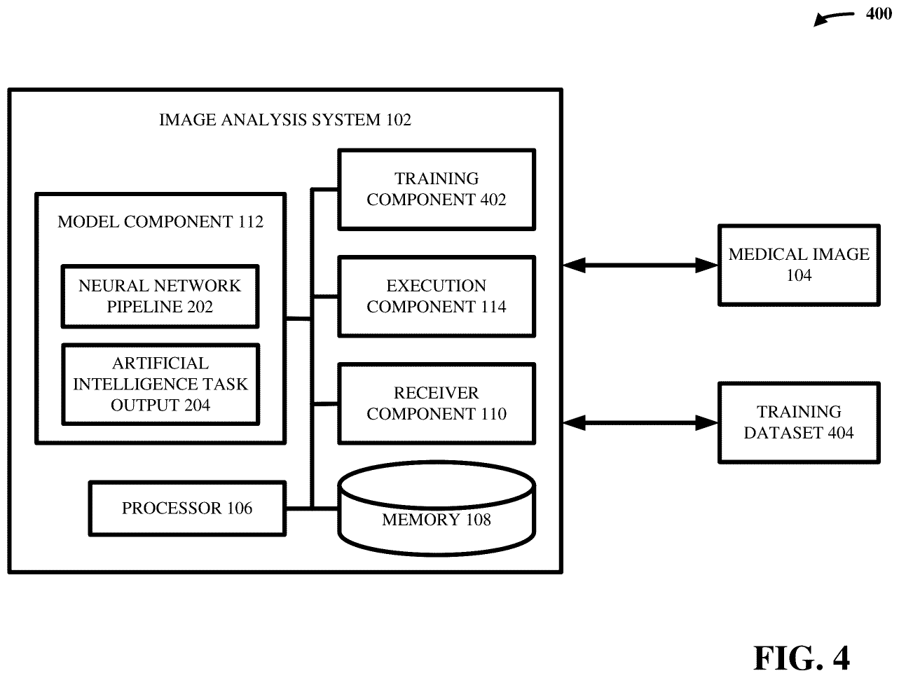

In order for the neural network pipeline 202 to accurately/precisely analyze the medical image 104, the neural network pipeline 202 should first undergo training. In various cases, such training is described with respect to FIGS. 4-7.

FIG. 4 illustrates a block diagram of an example, non-limiting system 400 including a training component and/or a training dataset that can facilitate improved neural network inferencing efficiency with fewer parameters in accordance with one or more embodiments described herein. As shown, the system 400 can, in some cases, comprise the same components as the system 200, and can further comprise a training component 402 and/or a training dataset 404.

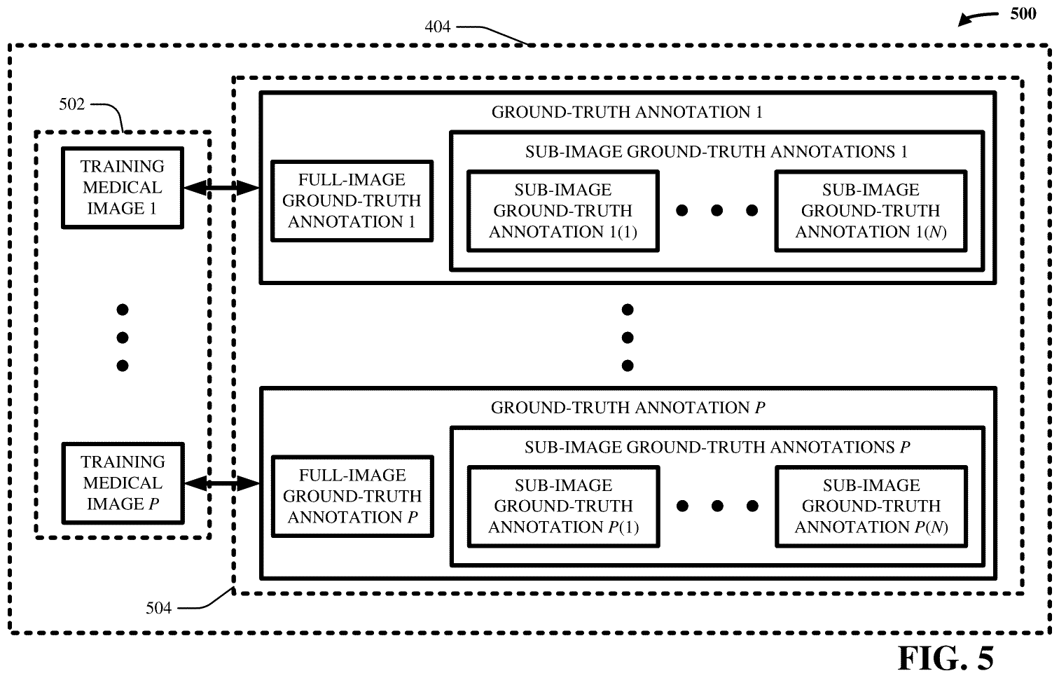

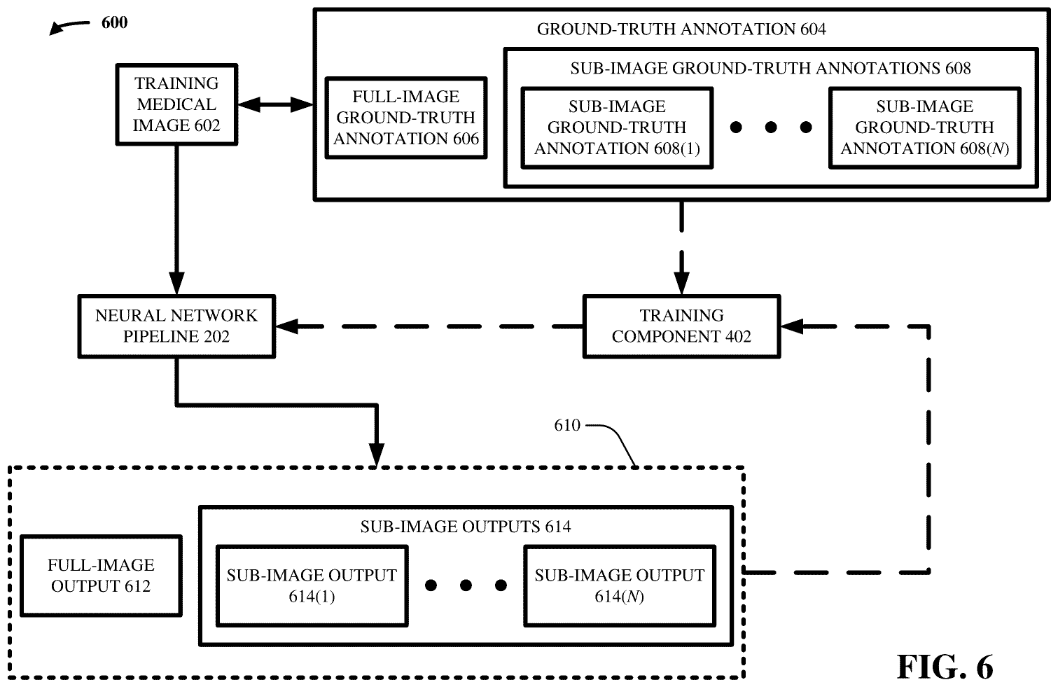

In various aspects, the receiver component 110 can electronically receive, retrieve, and/or otherwise access the training dataset 404, from any suitable source as desired. In various instances, the training component 402 can train, in supervised fashion, the neural network pipeline 202 on the training dataset 404. Such training is described in more detail with respect to FIGS. 5-6.

FIG. 5 illustrates a block diagram 500 of an example, non-limiting training dataset in accordance with one or more embodiments described herein. That is, FIG. 5 depicts a non-limiting example embodiment of the training dataset 404.

In various embodiments, as shown, the training dataset 404 can include a set of training medical images 502 and/or a set of ground-truth annotations 504. In various aspects, the set of training medical images 502 can include p images for any suitable positive integer p: a training medical image 1 to a training medical image p. In various instances, each of the set of training medical images 502 can have the same format and/or dimensionality as the medical image 104. As a non-limiting example, suppose that the medical image 104 is an x-by-y pixel array for any suitable positive integers x and y. In such case, each of the set of training medical images 502 can likewise be an x-by-y pixel array. As another non-limiting example, suppose that the medical image 104 is an x-by-y-by-z voxel array for any suitable positive integers x, y, and z. In such case, each the set of training medical images 502 can likewise be an x-by-y-by-z voxel array.

In various embodiments, the set of ground-truth annotations 504 can respectively correspond (e.g., in one-to-one fashion) to the set of training medical images 502. Thus, because the set of training medical images 502 can have p images, the set of ground-truth annotations 504 can have p annotations: a ground-truth annotation 1 to a ground-truth annotation p. In various aspects, each of the set of ground-truth annotations 504 can be any suitable electronic data (e.g., one or more scalars, one or more vectors, one or more matrices, one or more tensors, and/or one or more character strings) that indicates/represents accurate/correct results that would be obtained if the artificial intelligence task were accurately/correctly performed on a respective one of the set of training medical images 502. For example, the ground-truth annotation 1 can correspond to the training medical image 1, which can mean that the ground-truth annotation 1 can be considered as indicating the correct/accurate results that would be known/deemed to occur if the artificial intelligence task were accurately/correctly performed on the training medical image 1. Similarly, the ground-truth annotation p can correspond to the training medical image p, which can mean that the ground-truth annotation p can be considered as indicating the correct/accurate results that would be known/deemed to occur if the artificial intelligence task were accurately/correctly performed on the training medical image p.

In various aspects, as shown, each ground-truth annotation can include both a full-image ground-truth annotation and a set of sub-image ground-truth annotations. In various instances, each full-image ground-truth annotation can be considered as the correct/accurate result/activations that should be outputted by the one or more aggregation layers 312 when the neural network pipeline 202 is executed on a respective training medical image. In contrast, each set of sub-image ground-truth annotations can be considered as the correct/accurate results/activations that should be outputted by the sub-network 308 when the neural network pipeline 202 is executed on a respective training medical image.

As a non-limiting example, the ground-truth annotation 1 can comprise a full-image ground-truth annotation 1 and a set of sub-image ground-truth annotations 1. In various aspects, the full-image ground-truth annotation 1 can be considered as the accurate/correct result that would be outputted by the one or more aggregation layers 312 if the neural network pipeline 202 were accurately/correctly executed on the training medical image 1. Accordingly, the full-image ground-truth annotation 1 can exhibit the same format and/or dimensionality as the artificial intelligence task output 204. So, if the artificial intelligence task is image classification, then the full-image ground-truth annotation 1 can be the accurate/correct classification label that is known/deemed to correspond to the training medical image 1. In other cases, if the artificial intelligence task is image segmentation, then the full-image ground-truth annotation 1 can be the accurate/correct pixel-wise and/or voxel-wise segmentation mask that is known/deemed to correspond to the training medical image 1. In yet other cases, if the artificial intelligence task is image denoising, then the full-image ground-truth annotation 1 can be a denoised version of the training medical image 1 that is known/deemed to be accurate/correct.

In similar fashion, the set of sub-image ground-truth annotations 1 can be considered as the accurate/correct results that would be outputted by the sub-network 308 if the neural network pipeline 202 were accurately/correctly executed on the training medical image 1. Accordingly, the set of sub-image ground-truth annotations 1 can exhibit the same format and/or dimensionality as the set of sub-outputs 310. So, if the artificial intelligence task is image classification, then the set of sub-image ground-truth annotations 1 can be the accurate/correct classification labels that are known/deemed to correspond to down-sampled sub-images of the training medical image 1 (e.g., a sub-image ground-truth annotation 1(1) can be the accurate/correct classification label that is known/deemed to correspond to a first down-sampled sub-image of the training medical image 1; a sub-image ground-truth annotation 1(n) can be the accurate/correct classification label that is known/deemed to correspond to an n-th down-sampled sub-image of the training medical image 1). In other cases, if the artificial intelligence task is image segmentation, then the set of sub-image ground-truth annotations 1 can be the accurate/correct pixel-wise and/or voxel-wise segmentation masks that are known/deemed to correspond to down-sampled sub-images of the training medical image 1 (e.g., the sub-image ground-truth annotation 1(1) can be the accurate/correct segmentation mask that is known/deemed to correspond to a first down-sampled sub-image of the training medical image 1; the sub-image ground-truth annotation 1 (n) can be the accurate/correct segmentation mask that is known/deemed to correspond to an n-th down-sampled sub-image of the training medical image 1). In yet other cases, if the artificial intelligence task is image denoising, then the set of sub-image ground-truth annotations 1 can be the accurate/correct denoised sub-images that are known/deemed to correspond to down-sampled sub-images of the training medical image 1 (e.g., the sub-image ground-truth annotation 1(1) can be the accurate/correct denoised version of a first down-sampled sub-image of the training medical image 1; the sub-image ground-truth annotation 1 (n) can be the accurate/correct denoised version of an n-th down-sampled sub-image of the training medical image 1).

As another non-limiting example, the ground-truth annotation p can comprise a full-image ground-truth annotation p and a set of sub-image ground-truth annotations p. In various aspects, the full-image ground-truth annotation p can be considered as the accurate/correct result that would be outputted by the one or more aggregation layers 312 if the neural network pipeline 202 were accurately/correctly executed on the training medical image p. Accordingly, just as above, the full-image ground-truth annotation p can exhibit the same format and/or dimensionality as the artificial intelligence task output 204. So, if the artificial intelligence task is image classification, then the full-image ground-truth annotation p can be the accurate/correct classification label that is known/deemed to correspond to the training medical image p. In other cases, if the artificial intelligence task is image segmentation, then the full-image ground-truth annotation p can be the accurate/correct pixel-wise and/or voxel-wise segmentation mask that is known/deemed to correspond to the training medical image p. In yet other cases, if the artificial intelligence task is image denoising, then the full-image ground-truth annotation p can be a denoised version of the training medical image p that is known/deemed to be accurate/correct.

In similar fashion, and just as above, the set of sub-image ground-truth annotations p can be considered as the accurate/correct results that would be outputted by the sub-network 308 if the neural network pipeline 202 were accurately/correctly executed on the training medical image p. Accordingly, the set of sub-image ground-truth annotations p can exhibit the same format and/or dimensionality as the set of sub-outputs 310. So, if the artificial intelligence task is image classification, then the set of sub-image ground-truth annotations p can be the accurate/correct classification labels that are known/deemed to correspond to down-sampled sub-images of the training medical image p (e.g., a sub-image ground-truth annotation p(1) can be the accurate/correct classification label that is known/deemed to correspond to a first down-sampled sub-image of the training medical image p; a sub-image ground-truth annotation p(n) can be the accurate/correct classification label that is known/deemed to correspond to an n-th down-sampled sub-image of the training medical image p). In other cases, if the artificial intelligence task is image segmentation, then the set of sub-image ground-truth annotations p can be the accurate/correct pixel-wise and/or voxel-wise segmentation masks that are known/deemed to correspond to down-sampled sub-images of the training medical image p (e.g., the sub-image ground-truth annotation p(1) can be the accurate/correct segmentation mask that is known/deemed to correspond to a first down-sampled sub-image of the training medical image p; the sub-image ground-truth annotation p(n) can be the accurate/correct segmentation mask that is known/deemed to correspond to an n-th down-sampled sub-image of the training medical image p). In yet other cases, if the artificial intelligence task is image denoising, then the set of sub-image ground-truth annotations p can be the accurate/correct denoised sub-images that are known/deemed to correspond to down-sampled sub-images of the training medical image p (e.g., the sub-image ground-truth annotation p(1) can be the accurate/correct denoised version of a first down-sampled sub-image of the training medical image p; the sub-image ground-truth annotation p(n) can be the accurate/correct denoised version of an n-th down-sampled sub-image of the training medical image p).

FIG. 6 illustrates an example, non-limiting block diagram 600 showing how the neural network pipeline 202 can be trained on the training dataset 404 in accordance with one or more embodiments described herein.

In various embodiments, the internal parameters (e.g., weight vectors/matrices, bias vectors/matrices, convolutional kernels) of the neural network pipeline 202 can be initialized in any suitable fashion (e.g., random initialization). In various aspects, the training component 402 can select a training medical image 602 from the set of training medical images 502. In various instances, the training medical image 602 can correspond to the ground-truth annotation 604 from the set of ground-truth annotations 504. In various cases, as shown, the ground-truth annotation 604 can include a full-image ground-truth annotation 606 and/or a set of sub-image ground-truth annotations 608. In various instances, as shown, the set of sub-image ground-truth annotations 608 can comprise a sub-image ground-truth annotation 608(1) to a sub-image ground-truth annotation 608(n).

In various aspects, the training component 402 can feed the training medical image 602 to the neural network pipeline 202, which can cause the neural network pipeline 202 to generate some output 610. In various instances, as shown, the output 610 can include a full-image output 612 and/or a set of sub-image outputs 614. In various cases, the set of sub-image outputs 614 can include a sub-image output 614(1) to a sub-image output 614(n). More specifically, the one or more decomposition layers 302 can receive the training medical image 602 as input and can produce as output a set of n down-sampled sub-images of the training medical image 602. In various aspects, the set of n down-sampled sub-images of the training medical image 602 can respectively complete forward passes through the set of parallel sub-networks 306. In various instances, the activations outputted by the set of parallel sub-networks 306 can then collectively complete a forward pass through the sub-network 308, which can cause the sub-network 308 to produce the set of sub-image outputs 614. In various cases, the set of sub-image outputs 614 can then complete a forward pass through the one or more aggregation layers 312, and the one or more aggregation layers 312 can produce the full-image output 612.

In various aspects, the output 610 can be considered as the artificial intelligence results which the neural network pipeline 202 believes/infers should correspond to the training medical image 602 (e.g., the full-image output 612 can be the classification label, segmentation mask, and/or denoised version which the neural network pipeline 202 believes/infers corresponds to the training medical image 602; and/or the set of sub-image outputs 614 can be the classification labels, segmentation masks, and/or denoised versions which the neural network pipeline 202 believes/infers corresponds to the n down-sampled sub-images of the training medical image 602). In contrast, the ground-truth annotation 604 can be considered as the correct/accurate artificial intelligence results which are known/deemed to correspond to the training medical image 602 (e.g., the full-image ground-truth annotation 606 can be the correct/accurate classification label, segmentation mask, and/or denoised version which is known/deemed to correspond to the training medical image 602; and/or the set of sub-image ground-truth annotations 608 can be the correct/accurate classification labels, segmentation masks, and/or denoised versions which are known/deemed to correspond to the n down-sampled sub-images of the training medical image 602). Note that, if the neural network pipeline 202 has so far undergone no and/or little training, then the output 610 can be very different from the ground-truth annotation 604 (e.g., the full-image output 612 can be very different from the full-image ground-truth annotation 606; and/or the set of sub-image outputs 614 can respectively be very different from the set of sub-image ground-truth annotations 608).

In any case, the training component 402 can electronically compute (e.g., via any suitable objective functions) various errors/losses between the output 610 and the ground-truth annotation 604, and the training component 402 can iteratively update the internal parameters of the neural network pipeline 202 via backpropagation, where such backpropagation can be driven by the computed errors/losses. More specifically, in various aspects, the training component 402 can compute a first error/loss between the full-image output 612 and the full-image ground-truth annotation 606. Moreover, in various instances, the training component 402 can compute a set of second errors/losses between respective ones of the set of sub-image outputs 614 and the set of sub-image ground-truth annotations 608 (e.g., can compute an error/loss between the sub-image output 614(1) and the sub-image ground-truth annotation 608(1); can compute an error/loss between the sub-image output 614(n) and the sub-image ground-truth annotation 608(n)). In various cases, the training component 402 can perform backpropagation on the set of parallel sub-networks 306 (and/or on the sub-network 308, in some cases), where such backpropagation can be driven by the set of second errors/losses (e.g., by an average of such set of second errors/losses). In various aspects, the training component 402 can perform backpropagation on the remainder of the neural network pipeline 202 (e.g., on the one or more aggregation layers 312, and/or on the sub-network 308), where such backpropagation can be driven by the first error/loss.

In various aspects, the above training procedure can be repeated for each training medical image in the training dataset 404, which can cause the internal parameters of the neural network pipeline 202 to become iteratively optimized for accurately applying the artificial intelligence task to inputted medical images. As those having ordinary skill in the art will appreciate, the training component 402 can implement any suitable error/loss/objective functions, any suitable training termination criteria, and/or any suitable training batch sizes.

Note that, as explained with respect to FIG. 6, backpropagation can be performed on the set of parallel sub-networks 306 based on the set of sub-image ground-truth annotations 608. Furthermore, note that separate backpropagation can be performed on the remainder of the neural network pipeline 202 based on the full-image ground-truth annotation 606. In various cases, such training can be referred to as sub-network supervision (e.g., since the set of parallel sub-networks 306 can be considered as being trained separately and/or independently of the remainder of the neural network pipeline 202). As experimentally verified by the present inventors, such sub-network supervision can help to maintain (and/or even boost) accuracy/precision of the neural network pipeline 202, despite a reduction in total number of internal parameters caused by the skip connections 314 and/or by the sharing of weights across the set of parallel sub-networks 306.

In various embodiments, the present inventors realized that training of the neural network pipeline 202 can be further improved by enforcing a translation-invariant loss. In some cases, this can be implemented with ground-truths as follows. For any given training medical image in the set of training medical images 502, there can be a given full-image ground-truth annotation in the set of ground-truth annotations 504 that corresponds to the given training medical image. In various instances, the training component 402 can shift and/or translate, in any suitable direction and/or by any suitable magnitude, the pixels/voxels of the given training medical image, thereby yielding a shifted/translated training medical image. As a non-limiting example, the training component 402 can shift/translate all of the pixels/voxels of the given training medical image upward by s spaces, for any suitable positive integer s, and rightward by t spaces, for any suitable positive integer t. In various aspects, if the artificial intelligence task is image classification, then the given full-image ground-truth annotation can be considered as representing the accurate/correct classification label for the shifted/translated training medical image. Accordingly, the training component 402 can feed the shifted/translated training medical image to the neural network pipeline 202, can compute an error/loss between the output of the neural network pipeline 202 and the given full-image ground-truth annotation, and/or can update the internal parameters of the neural network pipeline 202 based on such error/loss. On the other hand, if the artificial intelligence task is an image-to-image task (e.g., image segmentation, image denoising), then the given full-image ground-truth annotation cannot be considered as representing the accurate/correct classification label for the shifted/translated training medical image. Instead, the training component 402 can shift/translate the given full-image ground-truth annotation in the same direction and/or by the same magnitude as the given training medical image, thereby yielding a shifted/translated full-image ground-truth annotation. For example, if the training component 402 shifts/translates the pixels/voxels of the given training medical image s units upward and t units rightward, then the training component 402 can likewise shift/translate the pixels/voxels of the given full-image ground-truth annotation s units upward and t units rightward. In various cases, the shifted/translated full-image ground-truth annotation can be considered as representing the accurate/correct artificial intelligence task result (e.g., the accurate/correct segmentation mask, the accurate/correct denoised version) for the shifted/translated training medical image. Accordingly, the training component 402 can feed the shifted/translated training medical image to the neural network pipeline 202, can compute an error/loss between the output of the neural network pipeline 202 and the shifted/translated full-image ground-truth annotation, and/or can update the internal parameters of the neural network pipeline 202 based on such error/loss. In any case, such training can cause the neural network pipeline 202 to become agnostic to pixel/voxel shifts and/or translations. Thus, such training can be referred to as translation-invariant training.

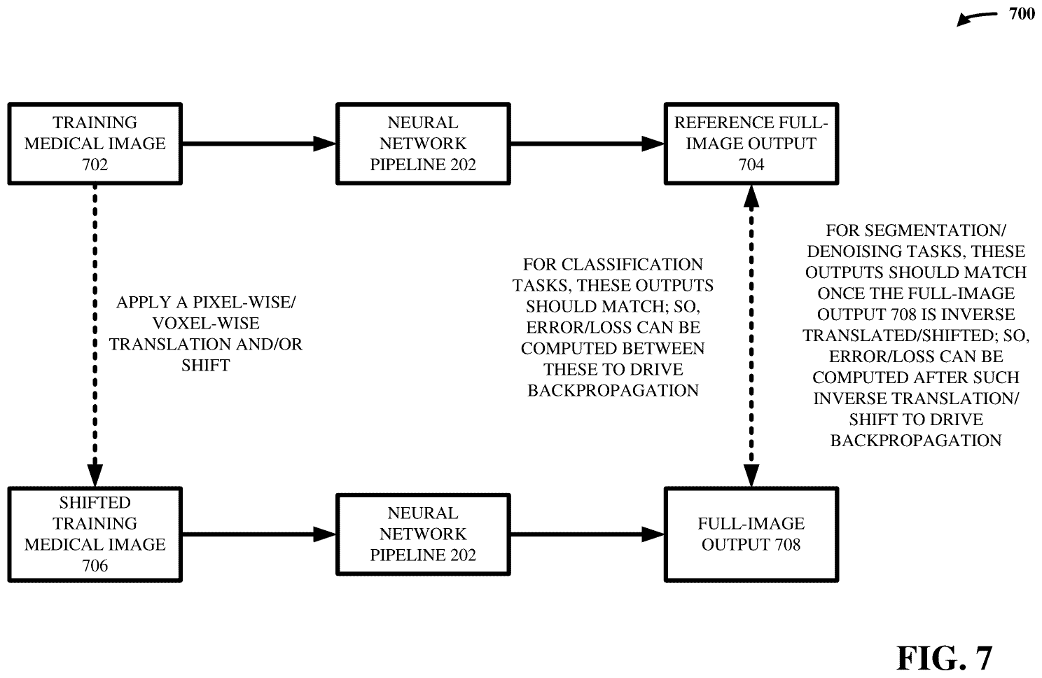

In various embodiments, such translation-invariant training can be implemented even in the absence of ground-truths. Such training is described with respect to FIG. 7.

FIG. 7 illustrates an example, non-limiting block diagram 700 showing how training of the neural network pipeline 202 can be improved via translation invariance in accordance with one or more embodiments described herein.

In various aspects, there can be a training medical image 702. In various instances, it can be the case that the training medical image 702 does not correspond to a ground-truth annotation (e.g., it can be the case that a ground-truth annotation for the training medical image 702 was never manually generated and/or is otherwise unknown/unavailable). Despite such lack of a ground-truth annotation, the training medical image 702 can nevertheless be leveraged to perform translation-invariant training of the neural network pipeline 202. Specifically, in various aspects, the training component 402 can execute the neural network pipeline 202 on the training medical image 702, thereby yielding a reference full-image output 704. In particular, the one or more decomposition layers 302 can decompose the training medical image 702 into a set of n down-sampled sub-images, the set of n down-sampled sub-images can respectively complete forward passes through the set of parallel sub-networks 306, the outputs of the set of parallel sub-networks 306 can complete a forward pass through the sub-network 308, thereby causing the sub-network 308 to produce a set of n sub-image outputs, and/or the set of n sub-image outputs can complete a forward pass through the one or more aggregation layers 312, thereby causing the one or more aggregation layers 312 to produce the reference full-image output 704 (e.g., the reference full-image output 704 can have the same format/dimensionality as the artificial intelligence task output 204).

Now, in various aspects, the training component 402 can apply any suitable pixel-wise and/or voxel-wise shift/translation to the training medical image 702, thereby yielding a shifted training medical image 706. As an example, the training component 402 can shift/translate the pixels/voxels of the training medical image 702 s units to the upward and/or t units rightward, for any suitable positive integers s and t. In various instances, the training component can execute the neural network pipeline 202 on the shifted training medical image 706, thereby yielding a full-image output 708. Just like above, the one or more decomposition layers 302 can decompose the shifted training medical image 706 into a set of n down-sampled sub-images, the set of n down-sampled sub-images can respectively complete forward passes through the set of parallel sub-networks 306, the outputs of the set of parallel sub-networks 306 can complete a forward pass through the sub-network 308, thereby causing the sub-network 308 to produce a set of n sub-image outputs, and/or the set of n sub-image outputs can complete a forward pass through the one or more aggregation layers 312, thereby causing the one or more aggregation layers 312 to produce the full-image output 708 (e.g., the full-image output 708 can have the same format/dimensionality as the artificial intelligence task output 204).

In various aspects, suppose that the artificial intelligence task is image classification. In such case, both the reference full-image output 704 and the full-image output 708 can be classification labels. Because the pixel-wise and/or voxel-wise shift applied by the training component 402 can be considered as not substantively changing the content of the training medical image 702, it can be expected that the full-image output 708 should be the same as the reference full-image output 704. Accordingly, the training component 402 can compute an error/loss between the full-image output 708 and the reference full-image output 704, and the training component 402 can update (e.g., via backpropagation) the internal parameters of the neural network pipeline 202 based on such error/loss.

In various other aspects, suppose that the artificial intelligence task is an image-to-image task, such as image segmentation and/or image denoising. In such case, both the reference full-image output 704 and the full-image output 708 can be pixel/voxel arrays (e.g., can be segmentation masks, can be denoised images). Although the pixel-wise and/or voxel-wise shift applied by the training component 402 can be considered as not substantively changing the content of the training medical image 702, it can change the positions of the pixels/voxels of the training medical image 702. So, in various instances, it can be expected that the full-image output 708 should be the same as the reference full-image output 704 after the full-image output 708 is inverse-shifted/inverse-translated (e.g., after the pixels/voxels of the full-image output 708 are shifted/translated by the same magnitudes but in opposite directions as those of the training medical image 702). Accordingly, the training component 402 can, in various aspects, inverse-shift and/or inverse-translate the full-image output 708. As a non-limiting example, if the training component shifted/translated the pixels/voxels of the training medical image 702 s units upward and/or t units rightward in order to create the shifted training medical image 706, then the training component 402 can shift/translate the pixels/voxels of the full-image output 708 s units downward (opposite of upward) and/or t units leftward (opposite of rightward). In any case, the training component can compute an error/loss between the reference full-image output 704 and the inverse-shifted version of the full-image output 708, and the training component 402 can update (e.g., via backpropagation) the internal parameters of the neural network pipeline 202 based on such error/loss. Just as above, such training can be considered as causing the neural network pipeline 202 to become agnostic to pixel-wise and/or voxel-wise shifts/translations.

No matter whether such translation-invariant training is facilitated with ground-truths (as described above) or without ground-truths (as described with respect to FIG. 7), the present inventors experimentally verified that such translation-invariant training can nevertheless help to preserve (and/or even boost) the accuracy/precision of the neural network pipeline 202, despite a reduction in total number of internal parameters due to the skip connections 314 and/or due to weight sharing among the set of parallel sub-networks 306.

Although the herein disclosure mainly describes translation-invariant loss as involving pixel-wise and/or voxel-wise shifts, this is a mere non-limiting example for ease of explanation. In various embodiments, translation-invariant loss training can be generalized to transformation-invariant loss training. That is, in various cases, any suitable physical transformation can be implemented, not just shifts/translations. For example, no matter the physical transformation that is applied to the training medical image 702 (e.g., it could be a shift/translation, and/or it could be a rotation, and/or it could be a reflection, and/or it could be a distortion), a generalized version of translation-invariant loss can be achieved by applying the inverse-transformation to the full-image output 708.

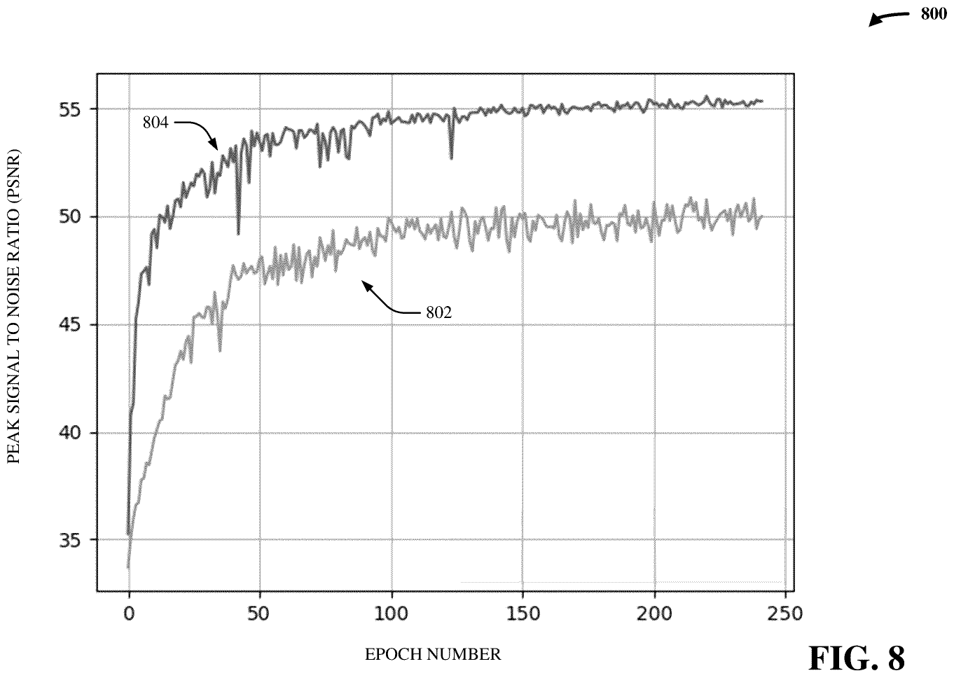

To validate the technical benefits of various embodiments described herein, the present inventors performed various experiments and achieved various results. Such results are described below, and some of such results are described with respect to FIGS. 8-11.

In particular, the present inventors reduced to practice a first neural network pipeline and a second neural network pipeline, both of which were configured to perform image denoising. In various cases, the first neural network pipeline was constructed according to FIG. 3. Additionally, the second neural network pipeline was constructed according to the FIG. 3, but lacked weight sharing among the set of parallel sub-networks 306 and lacked the skip connections 314. The first pipeline had fourteen layers with twenty-eight feature maps each and one layer with four feature maps, for a total of 103,455 internal parameters. In contrast, the second pipeline had fourteen layers with thirty-two feature maps each and one layer with four feature maps, for a total of 123,232 internal parameters (e.g., over 19% more internal parameters). Moreover, the first pipeline was trained with sub-network supervision and translation-invariant loss, whereas the second pipeline was trained without sub-network supervision and without translation-invariant loss. Upon execution, the present inventors noted that the first pipeline consumed an average of 3145 megabytes of RAM and 0.9 seconds of execution time, whereas the second network consumed an average of 3237 megabytes of RAM (e.g., 3% more RAM) and 1.26 seconds of execution time (e.g., 40% more execution time). These results clearly indicate that the first pipeline (e.g., which was constructed with the skip connections 314, with weight sharing among the set of parallel sub-networks 306, with sub-network supervision, and with translation-invariant loss) significantly outperformed the second pipeline (e.g., which was constructed without the skip connections 314, without weight sharing among the set of parallel sub-networks 306, without sub-network supervision, and without translation-invariant loss).

Furthermore, during training of the first pipeline and the second pipeline, the present inventors recorded peak signal-to-noise ratio (PSNR) as a function of epoch number. FIG. 8 depicts a graph 800, which graphically shows such recorded data. In particular, the x-axis of the graph 800 represents epoch number, the y-axis represents PSNR, numeral 802 represents the recorded PSNR of the second pipeline, and numeral 804 represents the recorded PSNR of the first pipeline. As shown, the PSNR of the first pipeline is substantially better than the PSNR of the second pipeline. Again, these results strongly indicate the benefits that can be obtained by the skip connections 314, by weight sharing among the set of parallel sub-networks 306, by sub-network supervision, and by translation-invariant loss training.

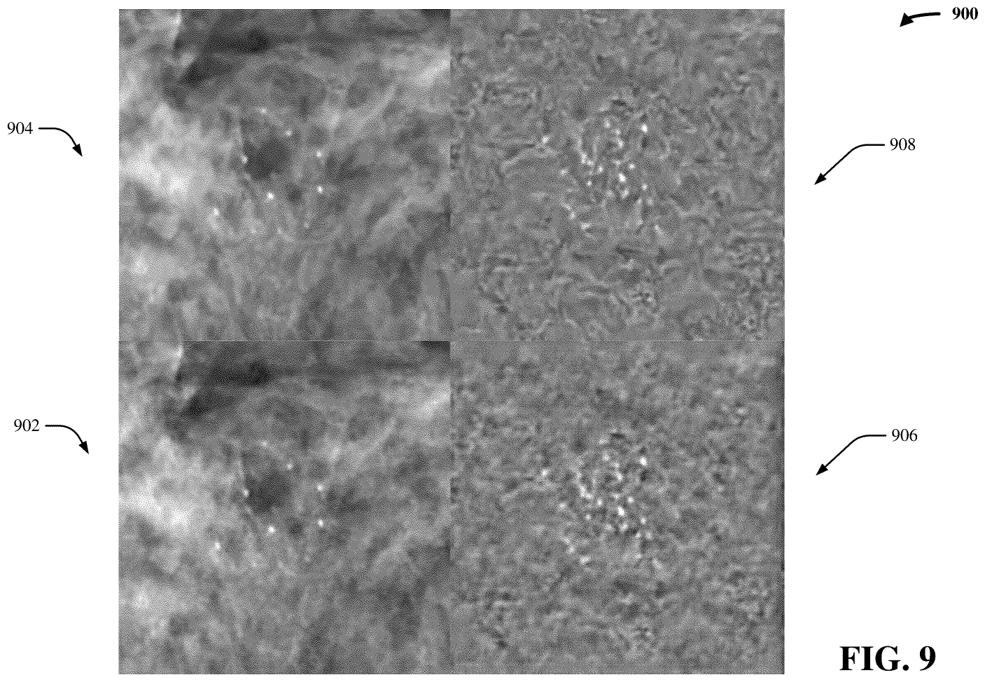

Further still, the present inventors visually compared various denoised outputs produced by the first pipeline and the second pipeline. Some of such denoised outputs are shown in diagram 900 of FIG. 9. Specifically, numeral 902 depicts a pixel patch from a denoised image produced by the second pipeline based on a given inputted image, and numeral 904 depicts a corresponding pixel patch from a denoised image produced by the first pipeline based on the same given inputted image. As those having ordinary skill in the art will appreciate, the pixel patch shown in numeral 902 exhibits more visual artifacts (e.g., chess board and/or grid artifacts) than the pixel patch shown in the numeral 904. Similarly, numeral 906 depicts a pixel patch from a denoised image produced by the second pipeline based on some other inputted image, and numeral 908 depicts a corresponding pixel patch from a denoised image produced by the first pipeline based on that same other inputted image. Again, as those having ordinary skill in the art will again appreciate, the pixel patch shown in numeral 906 exhibits more visual artifacts (e.g., chess board and/or grid artifacts) than the pixel patch shown in the numeral 908. Once more, these results strongly indicate the benefits that can be obtained by the skip connections 314, by weight sharing among the set of parallel sub-networks 306, by sub-network supervision, and by translation-invariant loss training.

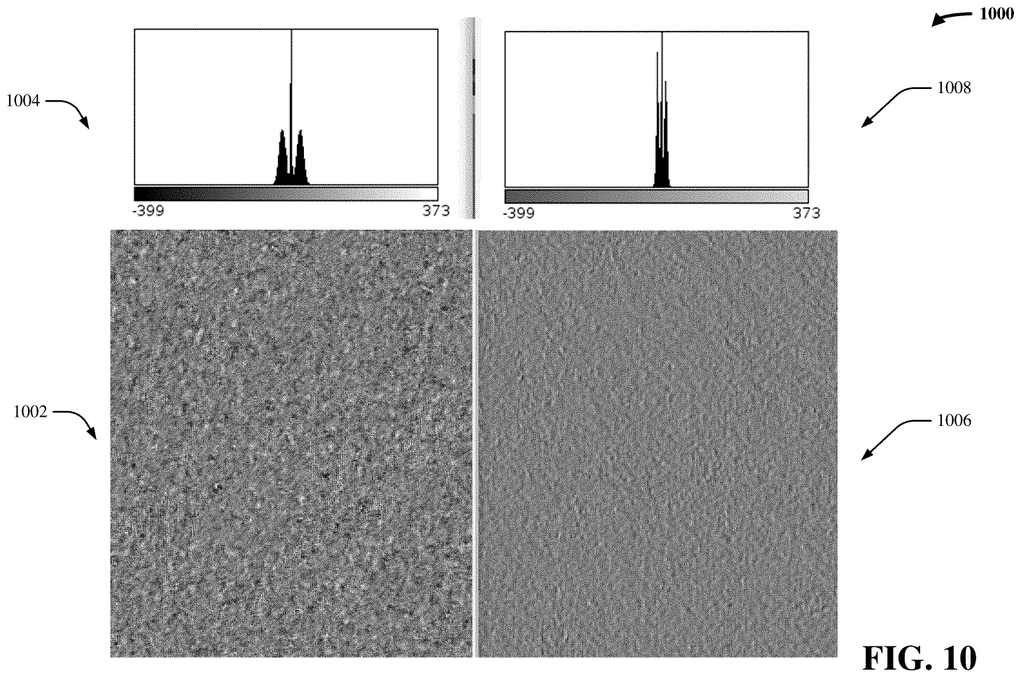

As mentioned above, the present inventors visually compared various denoised outputs produced by the first pipeline and the second pipeline. Another example of such denoised outputs is shown in diagram 1000 of FIG. 10. Specifically, numeral 1002 depicts a pixel patch from a denoised image produced by the second pipeline based on some inputted image, and numeral 1006 depicts a pixel patch from a denoised image produced by the first pipeline based on that same inputted image. As can easily be seen, the pixel patch of the numeral 1006 includes far less visual noise than the pixel patch of the numeral 1002. Furthermore, to help quantify this improvement, the present inventors plotted the pixel distributions of such pixel patches. In particular, numeral 1004 shows a pixel distribution for the pixel patch shown in the numeral 1002, whereas numeral 1008 shows a pixel distribution for the pixel patch shown in the numeral 1006. As can be seen, the pixel distribution in the numeral 1004 is much less tight and/or is much more spread-out than the pixel distribution in the numeral 1008. Again, such results strongly indicate the benefits that can be obtained by the skip connections 314, by weight sharing among the set of parallel sub-networks 306, by sub-network supervision, and by translation-invariant loss training.

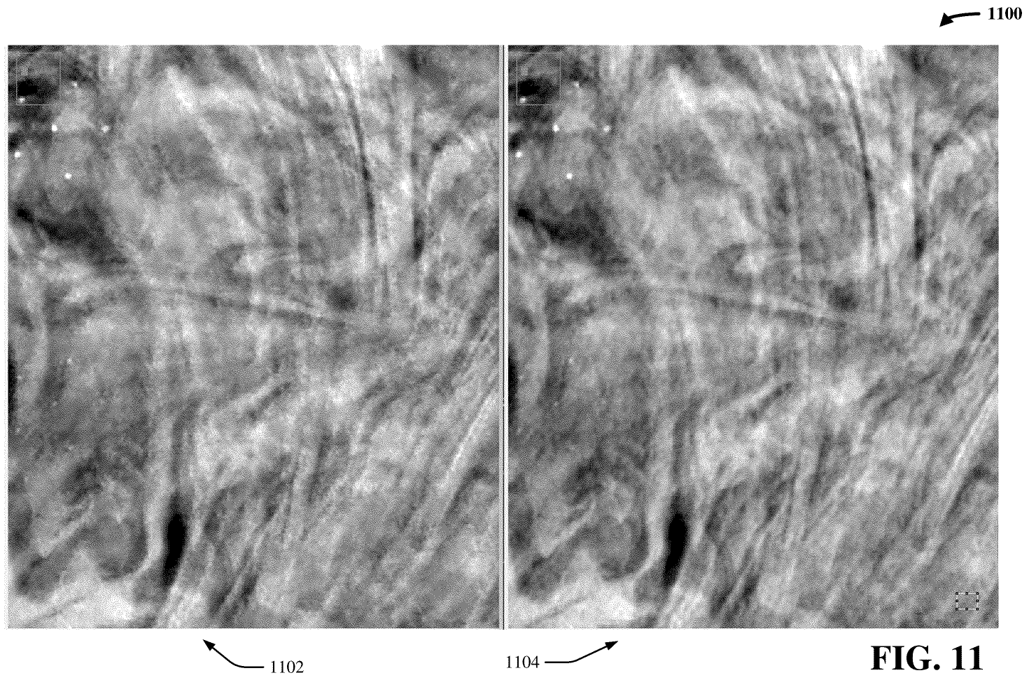

Once more, the present inventors visually compared various denoised outputs produced by the first pipeline and the second pipeline. Another example of such denoised outputs is shown in diagram 1100 of FIG. 11. Specifically, numeral 1102 depicts a pixel patch from a denoised image produced by the second pipeline based on a particular inputted image, and numeral 1104 depicts a corresponding pixel patch from a denoised image produced by the first pipeline based on the same particular inputted image. As those having ordinary skill in the art will appreciate, the pixel patch shown in numeral 1102 exhibits more visual artifacts than the pixel patch shown in the numeral 1104. Yet again, these results indicate the benefits that can be obtained by the skip connections 314, by weight sharing among the set of parallel sub-networks 306, by sub-network supervision, and by translation-invariant loss training.

Although not explicitly shown in the figures, the present inventors performed many other experiments, and the results of such experiments strongly indicated the technical benefits of various embodiments described herein. Indeed, in one case, the present inventors constructed a convolutional neural network having 1,199,882 internal parameters that was able to achieve an accuracy level of 0.9916 by consuming 2356 megabytes of RAM. By implementing skip connections from the input image to each/every convolutional layer in the network, the total number of internal parameters was reduced to 691,098 (e.g., almost 43% fewer parameters), and the accuracy level was essentially maintained (actually slightly improved) at 0.9917. This helps to show the benefits of the skip connections 314.

In another case, the present inventors constructed a fast and flexible denoising convolutional neural network (e.g., FFDNet) having 225,898 internal parameters, achieving an accuracy level of 0.9934, and consuming 1420 megabytes of RAM and 1.76 seconds of execution time. By implementing shared weights and sub-network supervision as described herein, the total number of internal parameters was reduced to 112,456 (e.g., over 50% fewer internal parameters), the consumed RAM was decreased to 1390 megabytes, the execution time was decreased to 1.74 seconds, and yet the accuracy level was essentially maintained (actually slightly improved) at 0.9935. When skip connections as described herein were also implemented, the total number of parameters was just 112,600 (e.g., still over 50% reduction), the consumed RAM was still 1390 megabytes, the execution time was still 1.74 seconds, and the accuracy was boosted even further to 0.9938. Again, these results help to show the real-world benefits of various embodiments described herein.

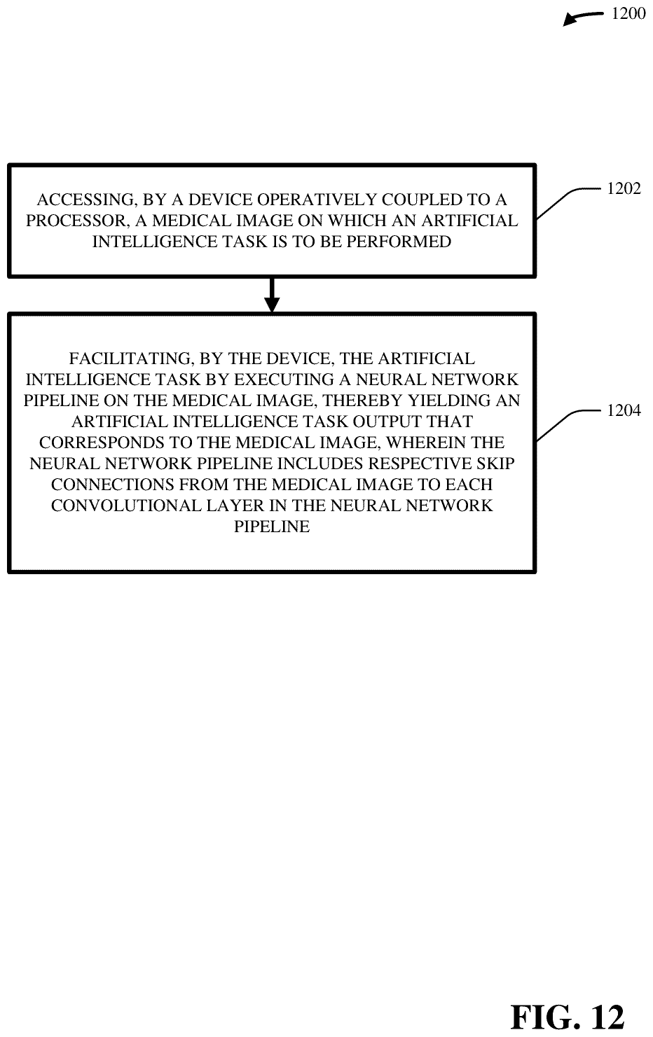

FIG. 12 illustrates a flow diagram of an example, non-limiting computer-implemented method 1200 that can facilitate improved neural network inferencing efficiency with fewer parameters in accordance with one or more embodiments described herein. In various cases, the image analysis system 102 can facilitate the computer-implemented method 1200.

In various embodiments, act 1202 can include accessing, by a device (e.g., via 110) operatively coupled to a processor, a medical image (e.g., 104) on which an artificial intelligence task is to be performed.

In various aspects, act 1204 can include facilitating, by the device (e.g., via 112), the artificial intelligence task by executing a neural network pipeline (e.g., 202) on the medical image, thereby yielding an artificial intelligence task output (e.g., 204) that corresponds to the medical image. In various cases, the neural network pipeline can include respective skip connections (e.g., 314) from the medical image, prior to any convolutions, to each convolutional layer in the neural network pipeline (e.g., as shown in FIG. 3).

Although not explicitly shown in FIG. 12, the artificial intelligence task can be image classification, and the computer-implemented method 1200 can further comprise: executing, by the device (e.g., via 402), the neural network pipeline on a training medical image (e.g., 702), thereby yielding a reference full-image output (e.g., 704); shifting, by the device (e.g., via 402), the training medical image in pixel-wise or voxel-wise fashion, thereby yielding a shifted training medical image (e.g., 706); executing, by the device (e.g., via 402), the neural network pipeline on the shifted training medical image, thereby yielding another full-image output (e.g., 708); and updating, by the device (e.g., via 402), internal parameters of the neural network pipeline based on an error between the reference full-image output and the another full-image output (e.g., as shown in FIG. 7).

Although not explicitly shown in FIG. 12, the artificial intelligence task can be image segmentation or image denoising, and the computer-implemented method 1200 can further comprise: executing, by the device (e.g., via 402), the neural network pipeline on a training medical image (e.g., 702), thereby yielding a reference full-image output (e.g., 704); shifting, by the device (e.g., via 402), the training medical image in pixel-wise or voxel-wise fashion, thereby yielding a shifted training medical image (e.g., 706); executing, by the device, the neural network pipeline on the shifted training medical image, thereby yielding another full-image output (e.g., 708); inverse-shifting, by the device, the another full-image output in pixel-wise or voxel-wise fashion, thereby yielding an inverse-shifted full-image output (e.g., described with respect to FIG. 7); and updating, by the device (e.g., via 402), internal parameters of the neural network pipeline based on an error between the reference full-image output and the inverse-shifted full-image output (e.g., as shown in FIG. 7).

Although not explicitly shown in FIG. 12, the neural network pipeline can further include: a decomposition layer (e.g., 302) that can decompose the medical image into a plurality of down-sampled sub-images (e.g., 304); and a plurality of parallel sub-networks (e.g., 306) that can respectively analyze the plurality of down-sampled sub-images, wherein the plurality of parallel sub-networks can have shared weights.

Although not explicitly shown in FIG. 12, the computer-implemented method 1200 can further comprise: training, by the device (e.g., via 402), the neural network pipeline on a training dataset (e.g., 404), wherein the training dataset can include a set of training medical images (e.g., 502), wherein each of the set of training medical images can correspond to a full-image ground-truth annotation (e.g., full-image ground-truth annotation 1) and a plurality of down-sampled sub-image ground-truth annotations (e.g., set of sub-image ground-truth annotations 1), wherein such pluralities of down-sampled sub-image ground-truth annotations can be leveraged to train the plurality of parallel sub-networks, and wherein such full-image ground-truth annotations can be leveraged to train a remainder of the neural network pipeline (e.g., as shown with respect to FIGS. 5-6).

Accordingly, various embodiments described herein can be considered as a computerized tool that can facilitate improved neural network inferencing efficiency with fewer parameters. In various aspects, such computerized tool can achieve this via implementing any suitable combination of: skip connections between an inputted image and each/every convolutional layer in a neural network pipeline; shared weights between parallel sub-networks in the pipeline; sub-network supervised trained; and/or translation-invariant training. Because various embodiments described herein can reduce the total number of internal parameters of a neural network (e.g., thereby reducing the RAM consumption and/or execution time of the neural network) while simultaneously preserving (and/or even boosting, in some cases) the performance of the neural network, such embodiments certainly constitute concrete and tangible technical improvements in the field of neural networks.

Although the herein disclosure mainly describes various embodiments as relating to medical images, this is a mere non-limiting example. Those having ordinary skill in the art will appreciate that the herein-described teachings can be extrapolated to any suitable images as desired (e.g., not limited to neural network pipelines that analyze just medical images).

In various instances, machine learning algorithms and/or models can be implemented in any suitable way to facilitate any suitable aspects described herein. To facilitate some of the above-described machine learning aspects of various embodiments, consider the following discussion of artificial intelligence (AI). Various embodiments described herein can employ artificial intelligence to facilitate automating one or more features and/or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system and/or environment from a set of observations as captured via events and/or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events and/or data.

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes and/or systems (e.g., support vector machines, neural networks, expert systems, Bayesian belief networks, fuzzy logic, data fusion engines, and so on) in connection with performing automatic and/or determined action in connection with the claimed subject matter. Thus, classification schemes and/or systems can be used to automatically learn and perform a number of functions, actions, and/or determinations.

A classifier can map an input attribute vector, z=(z₁, z₂, z₃, z₄, zₙ), to a confidence that the input belongs to a class, as by f(z)=confidence(class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence, any of which can be employed. Classification as used herein also is inclusive of statistical regression that is utilized to develop models of priority.

Those having ordinary skill in the art will appreciate that the herein disclosure describes non-limiting examples of various embodiments. For ease of description and/or explanation, various portions of the herein disclosure utilize the term “each” when discussing various embodiments. Those having ordinary skill in the art will appreciate that such usages of the term “each” are non-limiting examples. In other words, when the herein disclosure provides a description that is applied to “each” of some particular object and/or component, it should be understood that this is a non-limiting example of various embodiments, and it should be further understood that, in various other embodiments, it can be the case that such description applies to fewer than “each” of that particular object and/or component.

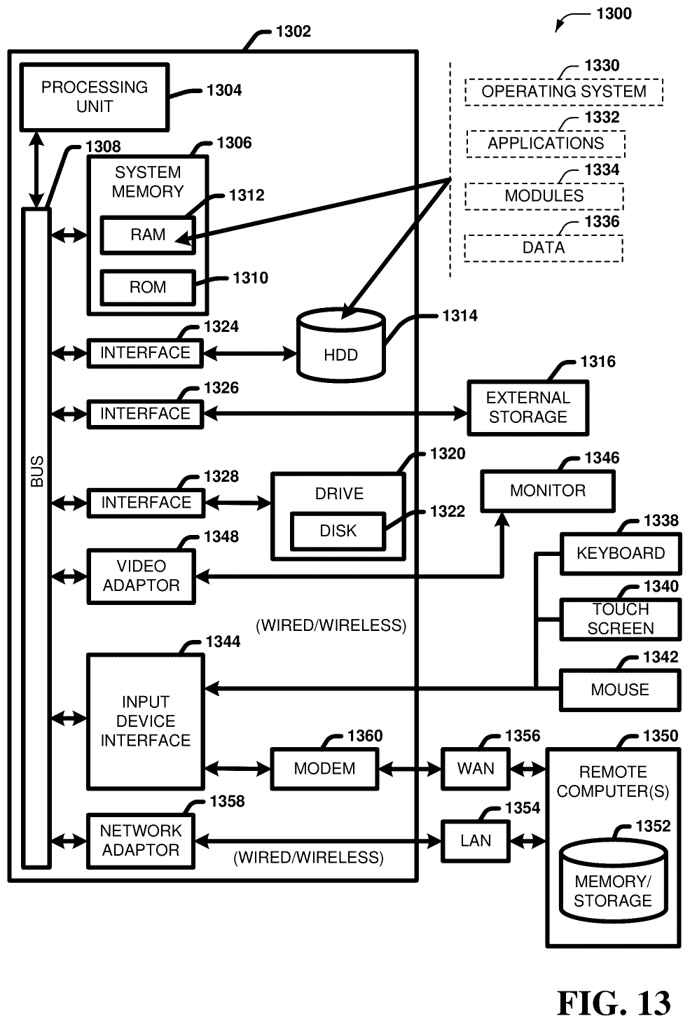

In order to provide additional context for various embodiments described herein, FIG. 13 and the following discussion are intended to provide a brief, general description of a suitable computing environment 1300 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 13, the example environment 1300 for implementing various embodiments of the aspects described herein includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures can also be employed as the processing unit 1304.

The system bus 1308 can be any of several types of bus structure that can further interconnect to a memory bus (with or without a memory controller), a peripheral bus, and a local bus using any of a variety of commercially available bus architectures. The system memory 1306 includes ROM 1310 and RAM 1312. A basic input/output system (BIOS) can be stored in a non-volatile memory such as ROM, erasable programmable read only memory (EPROM), EEPROM, which BIOS contains the basic routines that help to transfer information between elements within the computer 1302, such as during startup. The RAM 1312 can also include a high-speed RAM such as static RAM for caching data.

The computer 1302 further includes an internal hard disk drive (HDD) 1314 (e.g., EIDE, SATA), one or more external storage devices 1316 (e.g., a magnetic floppy disk drive (FDD) 1316, a memory stick or flash drive reader, a memory card reader, etc.) and a drive 1320, e.g., such as a solid state drive, an optical disk drive, which can read or write from a disk 1322, such as a CD-ROM disc, a DVD, a BD, etc. Alternatively, where a solid state drive is involved, disk 1322 would not be included, unless separate. While the internal HDD 1314 is illustrated as located within the computer 1302, the internal HDD 1314 can also be configured for external use in a suitable chassis (not shown). Additionally, while not shown in environment 1300, a solid state drive (SSD) could be used in addition to, or in place of, an HDD 1314. The HDD 1314, external storage device(s) 1316 and drive 1320 can be connected to the system bus 1308 by an HDD interface 1324, an external storage interface 1326 and a drive interface 1328, respectively. The interface 1324 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1302, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. The systems and methods described herein can be implemented utilizing various commercially available operating systems or combinations of operating systems.

Computer 1302 can optionally comprise emulation technologies. For example, a hypervisor (not shown) or other intermediary can emulate a hardware environment for operating system 1330, and the emulated hardware can optionally be different from the hardware illustrated in FIG. 13. In such an embodiment, operating system 1330 can comprise one virtual machine (VM) of multiple VMs hosted at computer 1302. Furthermore, operating system 1330 can provide runtime environments, such as the Java runtime environment or the .NET framework, for applications 1332. Runtime environments are consistent execution environments that allow applications 1332 to run on any operating system that includes the runtime environment. Similarly, operating system 1330 can support containers, and applications 1332 can be in the form of containers, which are lightweight, standalone, executable packages of software that include, e.g., code, runtime, system tools, system libraries and settings for an application.

Further, computer 1302 can be enable with a security module, such as a trusted processing module (TPM). For instance with a TPM, boot components hash next in time boot components, and wait for a match of results to secured values, before loading a next boot component. This process can take place at any layer in the code execution stack of computer 1302, e.g., applied at the application execution level or at the operating system (OS) kernel level, thereby enabling security at any level of code execution.

A user can enter commands and information into the computer 1302 through one or more wired/wireless input devices, e.g., a keyboard 1338, a touch screen 1340, and a pointing device, such as a mouse 1342. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1304 through an input device interface 1344 that can be coupled to the system bus 1308, but can be connected by other interfaces, such as a parallel port, an IEEE 1394 serial port, a game port, a USB port, an IR interface, a BLUETOOTH® interface, etc.

A monitor 1346 or other type of display device can be also connected to the system bus 1308 via an interface, such as a video adapter 1348. In addition to the monitor 1346, a computer typically includes other peripheral output devices (not shown), such as speakers, printers, etc.

The computer 1302 can operate in a networked environment using logical connections via wired and/or wireless communications to one or more remote computers, such as a remote computer(s) 1350. The remote computer(s) 1350 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1352 is illustrated. The logical connections depicted include wired/wireless connectivity to a local area network (LAN) 1354 and/or larger networks, e.g., a wide area network (WAN) 1356. Such LAN and WAN networking environments are commonplace in offices and companies, and facilitate enterprise-wide computer networks, such as intranets, all of which can connect to a global communications network, e.g., the Internet.

When used in a LAN networking environment, the computer 1302 can be connected to the local network 1354 through a wired and/or wireless communication network interface or adapter 1358. The adapter 1358 can facilitate wired or wireless communication to the LAN 1354, which can also include a wireless access point (AP) disposed thereon for communicating with the adapter 1358 in a wireless mode.

When used in a WAN networking environment, the computer 1302 can include a modem 1360 or can be connected to a communications server on the WAN 1356 via other means for establishing communications over the WAN 1356, such as by way of the Internet. The modem 1360, which can be internal or external and a wired or wireless device, can be connected to the system bus 1308 via the input device interface 1344. In a networked environment, program modules depicted relative to the computer 1302 or portions thereof, can be stored in the remote memory/storage device 1352. It will be appreciated that the network connections shown are example and other means of establishing a communications link between the computers can be used.

When used in either a LAN or WAN networking environment, the computer 1302 can access cloud storage systems or other network-based storage systems in addition to, or in place of, external storage devices 1316 as described above, such as but not limited to a network virtual machine providing one or more aspects of storage or processing of information. Generally, a connection between the computer 1302 and a cloud storage system can be established over a LAN 1354 or WAN 1356 e.g., by the adapter 1358 or modem 1360, respectively. Upon connecting the computer 1302 to an associated cloud storage system, the external storage interface 1326 can, with the aid of the adapter 1358 and/or modem 1360, manage storage provided by the cloud storage system as it would other types of external storage. For instance, the external storage interface 1326 can be configured to provide access to cloud storage sources as if those sources were physically connected to the computer 1302.

The computer 1302 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

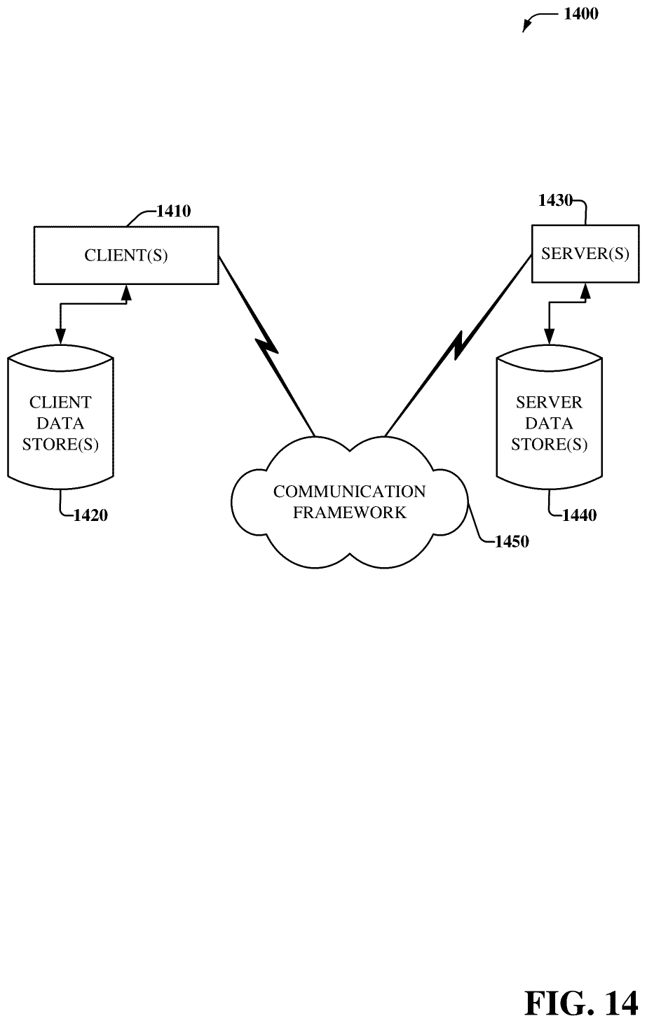

FIG. 14 is a schematic block diagram of a sample computing environment 1400 with which the disclosed subject matter can interact. The sample computing environment 1400 includes one or more client(s) 1410. The client(s) 1410 can be hardware and/or software (e.g., threads, processes, computing devices). The sample computing environment 1400 also includes one or more server(s) 1430. The server(s) 1430 can also be hardware and/or software (e.g., threads, processes, computing devices). The servers 1430 can house threads to perform transformations by employing one or more embodiments as described herein, for example. One possible communication between a client 1410 and a server 1430 can be in the form of a data packet adapted to be transmitted between two or more computer processes. The sample computing environment 1400 includes a communication framework 1450 that can be employed to facilitate communications between the client(s) 1410 and the server(s) 1430. The client(s) 1410 are operably connected to one or more client data store(s) 1420 that can be employed to store information local to the client(s) 1410. Similarly, the server(s) 1430 are operably connected to one or more server data store(s) 1440 that can be employed to store information local to the servers 1430.

The present invention may be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a processor that executes computer-executable components stored in a computer-readable memory, the computer-executable components comprising:
a receiver component that accesses a medical image on which an artificial intelligence task is to be performed; and
a model component that facilitates the artificial intelligence task by executing a neural network pipeline on the medical image, thereby yielding an artificial intelligence task output that corresponds to the medical image, wherein the neural network pipeline includes respective skip connections from the medical image, prior to any convolutions, to each convolutional layer in the neural network pipeline.

2. The system of claim 1, wherein the artificial intelligence task is image classification, and wherein the computer-executable components further comprise:
a training component that:
executes the neural network pipeline on a training medical image, thereby yielding a reference full-image output;
shifts the training medical image in pixel-wise or voxel-wise fashion, thereby yielding a shifted training medical image;
executes the neural network pipeline on the shifted training medical image, thereby yielding another full-image output; and
updates internal parameters of the neural network pipeline based on an error between the reference full-image output and the another full-image output.

3. The system of claim 1, wherein the artificial intelligence task is image segmentation or image denoising, and wherein the computer-executable components further comprise:
a training component that:
executes the neural network pipeline on a training medical image, thereby yielding a reference full-image output;
shifts the training medical image in pixel-wise or voxel-wise fashion, thereby yielding a shifted training medical image;
executes the neural network pipeline on the shifted training medical image, thereby yielding another full-image output;
inverse-shifts the another full-image output in pixel-wise or voxel-wise fashion, thereby yielding an inverse-shifted full-image output; and
updates internal parameters of the neural network pipeline based on an error between the reference full-image output and the inverse-shifted full-image output.

4. The system of claim 1, wherein the neural network pipeline further includes:
a decomposition layer that decomposes the medical image into a plurality of down-sampled sub-images; and
a plurality of parallel sub-networks that respectively analyze the plurality of down-sampled sub-images, wherein the plurality of parallel sub-networks have shared weights.

5. The system of claim 4, wherein the computer-executable components further comprise:
a training component that trains the neural network pipeline on a training dataset, wherein the training dataset includes a set of training medical images, wherein each of the set of training medical images corresponds to a full-image ground-truth annotation and a plurality of down-sampled sub-image ground-truth annotations, wherein the training component leverages such pluralities of down-sampled sub-image ground-truth annotations to train the plurality of parallel sub-networks, and wherein the training component leverages such full-image ground-truth annotations to train a remainder of the neural network pipeline.

6. The system of claim 1, wherein the neural network pipeline exhibits a U-net architecture.

7. The system of claim 1, wherein the computer-executable components further comprise:
an execution component that visually renders the artificial intelligence task output on an electronic display or that transmits the artificial intelligence task output to a computing device.

8. A computer-implemented method, comprising:
accessing, by a device operatively coupled to a processor, a medical image on which an artificial intelligence task is to be performed; and
facilitating, by the device, the artificial intelligence task by executing a neural network pipeline on the medical image, thereby yielding an artificial intelligence task output that corresponds to the medical image, wherein the neural network pipeline includes respective skip connections from the medical image, prior to any convolutions, to each convolutional layer in the neural network pipeline.

9. The computer-implemented method of claim 8, wherein the artificial intelligence task is image classification, and further comprising:
executing, by the device, the neural network pipeline on a training medical image, thereby yielding a reference full-image output;
shifting, by the device, the training medical image in pixel-wise or voxel-wise fashion, thereby yielding a shifted training medical image;
executing, by the device, the neural network pipeline on the shifted training medical image, thereby yielding another full-image output; and
updating, by the device, internal parameters of the neural network pipeline based on an error between the reference full-image output and the another full-image output.

10. The computer-implemented method of claim 8, wherein the artificial intelligence task is image segmentation or image denoising, and further comprising:
executing, by the device, the neural network pipeline on a training medical image, thereby yielding a reference full-image output;
shifting, by the device, the training medical image in pixel-wise or voxel-wise fashion, thereby yielding a shifted training medical image;
executing, by the device, the neural network pipeline on the shifted training medical image, thereby yielding another full-image output;
inverse-shifting, by the device, the another full-image output in pixel-wise or voxel-wise fashion, thereby yielding an inverse-shifted full-image output; and
updating, by the device, internal parameters of the neural network pipeline based on an error between the reference full-image output and the inverse-shifted full-image output.

11. The computer-implemented method of claim 8, wherein the neural network pipeline further includes:
a decomposition layer that decomposes the medical image into a plurality of down-sampled sub-images; and
a plurality of parallel sub-networks that respectively analyze the plurality of down-sampled sub-images, wherein the plurality of parallel sub-networks have shared weights.

12. The computer-implemented method of claim 11, further comprising:
training, by the device, the neural network pipeline on a training dataset, wherein the training dataset includes a set of training medical images, wherein each of the set of training medical images corresponds to a full-image ground-truth annotation and a plurality of down-sampled sub-image ground-truth annotations, wherein such pluralities of down-sampled sub-image ground-truth annotations are leveraged to train the plurality of parallel sub-networks, and wherein such full-image ground-truth annotations are leveraged to train a remainder of the neural network pipeline.

13. The computer-implemented method of claim 8, wherein the neural network pipeline exhibits a U-net architecture.

14. The computer-implemented method of claim 8, further comprising:
visually rendering, by the device, the artificial intelligence task output on an electronic display or transmitting, by the device, the artificial intelligence task output to a computing device.

15. A computer program product for facilitating improved neural network inferencing efficiency with fewer parameters, the computer program product comprising a computer-readable memory having program instructions embodied therewith, the program instructions executable by a processor to cause the processor to:
access a medical image on which an artificial intelligence task is to be performed; and
facilitate the artificial intelligence task by executing a neural network pipeline on the medical image, thereby yielding an artificial intelligence task output that corresponds to the medical image, wherein the neural network pipeline includes respective skip connections from the medical image, prior to any convolutions, to each convolutional layer in the neural network pipeline.

16. The computer program product of claim 15, wherein the artificial intelligence task is image classification, and wherein the program instructions are further executable to cause the processor to:
execute the neural network pipeline on a training medical image, thereby yielding a reference full-image output;
shift the training medical image in pixel-wise or voxel-wise fashion, thereby yielding a shifted training medical image;
execute the neural network pipeline on the shifted training medical image, thereby yielding another full-image output; and
update internal parameters of the neural network pipeline based on an error between the reference full-image output and the another full-image output.

17. The computer program product of claim 15, wherein the artificial intelligence task is image segmentation or image denoising, and wherein the program instructions are further executable to cause the processor to:
execute the neural network pipeline on a training medical image, thereby yielding a reference full-image output;
shift the training medical image in pixel-wise or voxel-wise fashion, thereby yielding a shifted training medical image;
execute the neural network pipeline on the shifted training medical image, thereby yielding another full-image output;
inverse-shift the another full-image output in pixel-wise or voxel-wise fashion, thereby yielding an inverse-shifted full-image output; and
update internal parameters of the neural network pipeline based on an error between the reference full-image output and the inverse-shifted full-image output.

18. The computer program product of claim 15, wherein the neural network pipeline further includes:
a decomposition layer that decomposes the medical image into a plurality of down-sampled sub-images; and
a plurality of parallel sub-networks that respectively analyze the plurality of down-sampled sub-images, wherein the plurality of parallel sub-networks have shared weights.

19. The computer program product of claim 18, wherein the program instructions are further executable to cause the processor to:
train the neural network pipeline on a training dataset, wherein the training dataset includes a set of training medical images, wherein each of the set of training medical images corresponds to a full-image ground-truth annotation and a plurality of down-sampled sub-image ground-truth annotations, wherein the processor leverages such pluralities of down-sampled sub-image ground-truth annotations to train the plurality of parallel sub-networks, and wherein the processor leverages such full-image ground-truth annotations to train a remainder of the neural network pipeline.

20. The computer program product of claim 15, wherein the neural network pipeline exhibits a U-net architecture.
